(19) United States
(12) Patent Application Publication
(10) Pub. No.: US 2025/0143299 A1
(43) Pub. Date: May 8, 2025

(54) METHODS AND COMPOSITIONS FOR CONTROLLING PESTS IN VEGETABLES

(71) Applicant: Globachem NV, Sint-Truiden (BE)

(72) Inventors: Liesbeth ZWARTS, Sint-Truiden (BE); Francis CLAES, Sint-Truiden (BE)

(73) Assignee: Globachem NV, Sint-Truiden (BE)

(21) Appl. No.: 18/835,031

(22) PCT Filed: Jan. 23, 2023
(86) PCT No.: PCT/EP2023/051490

§ 371 Date: Aug. 1, 2024

(30) Foreign Application Priority Data
Feb. 1, 2022 (EP) 22154603.9

(51) Int. Cl. A01N 37/02; A01P 7/02; A01P 7/04

(52) U.S. Cl. CPC A01N 37/02; A01P 7/02; A01P 7/04

(57) ABSTRACT

The present invention relates to methods of controlling arthropod, particularly insect and/or acari, pests on vegetable plants with pelargonic acid which demonstrate highly effective insecticidal and acaricidal activity combined with low phytotoxicity.

The invention relates to pelargonic acid, in particular pelargonic acid compositions having arthropodicidal, particularly insecticidal and/or acaricidal, activity, and to methods of controlling arthropod pests on vegetable plants with pelargonic acid which demonstrate highly effective arthropodicidal activity combined with low phytotoxicity.

Arthropod pests cause significant economic damage in the field of agriculture. In response, solutions have been developed to deter or eradicate arthropods including pesticides, plants expressing resistant traits, and the use of natural predators.

Pelargonic acid has long been known as a non-selective, contact herbicide. It has now been surprisingly found that pelargonic acid used at selected rates is highly effective at controlling pests in vegetables. Due to the favorable environmental profile of pelargonic acid and the fact that it provides an alternative mode of action compared to many insecticides and acaricides currently widely used on vegetables, the present invention represents an important new solution for farmers to control or prevent damage of vegetable plants caused by insect and acari pests.

WO2017042554 relates to an insecticide or acaricide composition which demonstrates low phytotoxicity even at relatively high concentrations combined with highly effective insecticidal and acaricidal activity. The composition comprises: a fatty acid/amino acid salt, the fatty acid component comprising one or more unsaturated fatty acids having from 14 to 22 carbon atoms; and one or more saturated fatty acids having from 8 to 18 carbon atoms.

EP0617888 describes pesticidal compositions including a mixture of a fatty acid salt and an adjuvant to increase spreadability of the fatty acid salt, the adjuvant being either a fatty alcohol of 4-18 carbon atoms, or a fatty acid methyl- or ethyl-ester of 4-18 carbon atoms.

U.S. Pat. No. 5,030,658 describes arthropodicidal compositions which include a mono alpha carboxylic acid with 8-20 carbon atoms or a metal salt thereof, with a metal ion sequestering agent, chelating agent, or surfactant.

These publications teach that lower fatty acids, e.g., fatty acids having a carbon chain length below about 12 are known to display phytotoxic properties.

Therefore, a pesticide composition, in particular an insecticide and/or acaricide, which maintains effectiveness against pests but demonstrates low phytotoxicity, such as leaf scorching, would be beneficial.

### DETAILED DESCRIPTION

The fact that the pelargonic acid compositions of the present invention are well tolerated by plants at the concentrations required for controlling plant pests allows the treatment of above-ground parts of plants, of propagation stock and the locus of the plants, e.g., of the soil.

According to the invention all plants and plant parts can be treated. By plants is meant all plants and plant populations such as desirable and undesirable wild plants, cultivars and plant varieties.

By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

Pelargonic acid, when used according to the present invention, is well tolerated by the environment and when well tolerated by the plants is suitable for protecting plants and plant organs, for enhancing harvest yields and for improving the quality of the harvested material. The pelargonic acid compositions are active against normally sensitive and resistant pest species and against all or some stages of development.

As a skilled person will appreciate, the term “arthropod” is suited to descriptions of the present invention which relates to not only insects but also other organisms falling within the phylum Arthropoda which are relevant in agriculture, such as acari particularly phytopathogenic mites. However, “insect” and in particular “insecticide” are commonly used terms in the field of agriculture hence there may be occurrences where the terms are used interchangeably. It is nonetheless intended that the scope of the invention is understood to encompass agriculturally-relevant arthropods generally.

The compositions according to the invention are valuable active ingredients in the field of pest control, even at low rates of application, which have a very favorable pest control spectrum. The compositions according to the invention act against all or individual developmental stages of normally sensitive, but also resistant, animal pests, such as arthropods, particularly insects or representatives of the order Acarina. The arthropodicidal activity of the compositions according to the invention can manifest itself directly, i.e., in destruction of the pests, which takes place either immediately or only after some time has elapsed, for example during ecdysis, or indirectly, for example in a reduced oviposition and/or hatching rate, a good activity corresponding to a destruction rate (mortality) of at least 40% and higher.

“Low Phytotoxicity” of pelargonic acid, as used herein means that the toxic effect on plants is absent or at such a level so as not to adversely impact the growth and/or yield of the plant under a given set of test conditions, e.g., at a given concentration of pelargonic acid. Phytotoxic effects may be measured in a number of different ways, for example, according to the principals set out in OEPP/EPPO Bulletin (2014) 44(3), 265-273 “PP 1/135 (4) Phytotoxicity assessment”. The phytotoxic effect on plants may be assessed visually as a function of the percentage of discoloration to the leaves and/or the appearance of necrosis. When the pelargonic acid compositions are applied to the foliage of the vegetable plants in accordance with the teachings herein, will typically result in a level of phytotoxicity of less than 20%, preferably less than 15%, more preferably less than 10% necrosis of the leaves in comparison to untreated plants. Preferred uses of the invention will typically result in phytotoxicity of 7% or less, whilst the most preferred uses will typically result in phytotoxicity of 5% or less. The above values are approximate as any purely visual assessment is likely to contain a degree of subjectivity.

Pelargonic acid, according to the invention, can be used for controlling, i.e., containing or destroying, insect and/or acari pests which occur, in particular, on vegetable plants.

As used herein, the term “vegetable” includes Brassica oleracea (e.g., cabbage, Brussels sprouts, cauliflower, broccoli, kale, kohlrabi, red cabbage, Savoy cabbage, Chinese broccoli, collard greens); Brassica rapa (e.g., turnip, Chinese cabbage, napa cabbage, bok choy); Raphanus sativus (e.g., radish, daikon, seedpod varieties); Daucus carota (e.g., carrot); Pastinaca sativa (e.g., parsnip); Beta vulgaris (e.g., beetroot, sea beet, Swiss chard, sugar beet); Lactuca sativa (e.g., lettuce, celtuce); Asparagus officinalis (e.g., asparagus); Phaseolus vulgaris, Phaseolus coccineus and Phaseolus lunatus (e.g., green bean, French bean, runner bean, haricot bean, Lima bean); Viciafaba (e.g., broad bean); Pisum sativum (e.g., pea, snap pea, snow pea, split pea); Solanum tuberosum (e.g., potato); Solanum melongena (e.g., eggplant); Solanum lycopersicum (e.g., tomato); Cucumis sativus (e.g., cucumber); Cucurbita spp. (e.g., pumpkin, squash, marrow, zucchini, gourd); Allium cepa (e.g., onion, spring onion, scallion, shallot); Allium sativum (e.g., garlic); Allium ampeloprasum (e.g., leek, elephant garlic); Capsicum annuum (e.g., pepper, bell pepper, sweet pepper); Spinacia oleracea (e.g., spinach); Dioscorea spp. (e.g., yam); Ipomoea batatas (e.g., sweet potato); and Manihot esculenta (e.g., cassava).

Preferred target crops are, in particular, tomatoes, potatoes, okra, spinach, asparagus, cabbages, carrots, onions, or bell peppers.

Plants and plant cultivars which are preferably treated according to the invention include those that are resistant against herbicides or one or more biotic stresses, i.e., said plants show a better defense against animal and microbial pests, such as against nematodes, insects, acari, phytopathogenic fungi, bacteria, viruses and/or viroids. This includes plants made resistant to the above biotic stress by way of breeding, genetic modification through gene editing, e.g., CRISPR, or transformed by the use of recombinant DNA techniques (i.e., transgenic plants) such that that they are capable of synthesizing one or more selectively acting toxins, such as are known, for example, from toxin-producing bacteria, especially those of the genus Bacillus.

The toxin contained in the transgenic plants imparts to the plant tolerance to harmful insects. Such insects can occur in any taxonomic group of insects, but are especially commonly found in the beetles (Coleoptera), two-winged insects (Diptera) and moths (Lepidoptera).

The term “crops” is to be understood as including also crop plants which have been so transformed by the use of recombinant DNA techniques that they are capable of synthesizing antipathogenic substances having a selective action, such as, for example, the so-called “pathogenesis-related proteins” (PRPs, see e.g., EP-A-0 392225). Examples of such antipathogenic substances and transgenic plants capable of synthesizing such antipathogenic substances are known, for example, from EP-A-0 392225, WO 95/33818 and EP-A-0 353 191. The methods of producing such transgenic plants are generally known to the person skilled in the art and are described, for example, in the publications mentioned above.

Crops may also be modified for enhanced resistance to fungal (for example Fusarium, Anthracnose, or Phytophthora), bacterial (for example Pseudomonas) or viral (for example potato leafroll virus, tomato spotted wilt virus, cucumber mosaic virus) pathogens.

Crops also include those that have enhanced resistance to nematodes.

Particularly useful transgenic plants which may be treated according to the invention are plants containing transformation events, or combination of transformation events, that are listed for example in the databases from various national or regional regulatory agencies.

Plants and plant cultivars which may also be treated according to the invention are those plants which are resistant to one or more abiotic stresses, i.e., that already exhibit an increased plant health with respect to stress tolerance. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance. Preferably, the treatment of these plants and cultivars with the composition of the present invention additionally increases the overall plant health.

Plants and plant cultivars which may also be treated according to the invention, are those plants characterized by enhanced yield characteristics i.e., that already exhibit an increased plant health with respect to this feature. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability. Preferably, the treatment of these plants and cultivars with the composition of the present invention additionally increases the overall plant health.

Examples of the above-mentioned insect and acari pests include: pests from the phylum of the Arthropoda, in particular from the class of the Arachnida, for example Acarus spp., for example Acarus siro, Aceria kuko, Aceria sheldoni, Aculops spp., Aculus spp., for example Aculus fockeui, Aculus schlechtendali, Amblyomma spp., Amphitetranychus viennensis, Argas spp., Boophilus spp., Brevipalpus spp., for example Brevipalpus phoenicis, Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., for example Eotetranychus hicoriae, Epitrimerus pyri, Eutetranychus spp., for example Eutetranychus banksi, Eriophyes spp., for example Eriophyes pyri, Glycyphagus domesticus, Halotydeus destructor, Hemitarsonemus spp., for example Hemitarsonemus latus (=Polyphagotarsonemus latus), Hyalomma spp., Ixodes spp., Latrodectus spp., Loxosceles spp., Neutrombicula autumnalis, Nuphersa spp., Oligonychus spp., for example Oligonychus coffeae, Oligonychus coniferarum, Oligonychus ilicis, Oligonychus indicus, Oligonychus mangiferus, Oligonychus pratensis, Oligonychus punicae, Oligonychus yothersi, Omithodorus spp., Omithonyssus spp., Panonychus spp., for example Panonychus citri (=Metatetranychus citri), Panonychus ulmi (=Metatetranychus ulmi), Phyllocoptruta oleivora, Platytetranychus multidigituli, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., for example Tarsonemus confusus, Tarsonemus pallidus, Tetranychus spp., for example Tetranychus canadensis, Tetranychus cinnabarinus, Tetranychus turkestani, Tetranychus urticae, Trombicula alfreddugesi, Vaejovis spp., Vasates lycopersici;
from the class of the Chilopoda, for example Geophilus spp., Scutigera spp.;
from the order or the class of the Collembola, for example Onychiurus armatus; Sminthurus viridis;
from the class of the Diplopoda, for example Blaniulus guttulatus;
from the class of the Insecta, for example from the order of the Blattodea, for example Blatta orientalis, Blattella asahinai, Blattella germanica, Leucophaea maderae, Loboptera decipiens, Neostylopyga rhombifolia, Panchlora spp., Parcoblatta spp., Periplaneta spp., for example Periplaneta americana, Periplaneta australasiae, Pycnoscelus surinamensis, Supella longipalpa;
from the order of the Coleoptera, for example Acalymma vittatum, Acanthoscelides obtectus, Adoretus spp., Aethina tumida, Agelastica alni, Agrilus spp., for example Agrilus planipennis, Agrilus coxalis, Agrilus bilineatus, Agrilus anxius, Agriotes spp., for example Agriotes linneatus, Agriotes mancus, Alphitobius diaperinus, Altica chalybea, Amphimallon solstitialis, Anobium punctatum, Anoplophora spp., for example Anoplophora glabripennis, Anthonomus spp., for example Anthonomus grandis or Anthonomus rubi, Anthrenus spp., Apion spp., Apogonia spp., Atomaria spp., for example Atomaria linearis, Attagenus spp., Baris caerulescens, Bruchidius obtectus, Bruchus spp., for example Bruchus pisorum, Bruchus rufimanus, Cassida spp., Cerotoma trifurcata, Ceutorhynchus spp., for example Ceutorhynchus spp., for example Ceutorhynchus assimilis, Ceutorhynchus napi Gyll., Ceutorhynchus obstrictus, Ceutorhynchus pallidactylus, Ceutorhynchus picitarsis, Ceutorhynchus quadridens, Ceutorhynchus rapae, Chaetocnema spp., for example Chaetocnema confmis, Chaetocnema denticulata, Chaetocnema ectypa, Chaetocnema pulicaria, Cleonus mendicus, Conoderus spp., Cosmopolites spp., for example Cosmopolites sordidus, Costelytra zealandica, Crioeris spp., for example Crioceris asparagi, Crioceris duodecimpunctata, Ctenicera spp., Curculio spp., for example Curculio caryae, Curculio caryatrypes, Curculio obtusus, Curculio sayi, Cryptolestes ferrugineus, Cryptolestes pusillus, Cryptorhynchus lapathi, Cryptorhynchus mangiferae, Cylindrocopturus spp., Cylindrocopturus adspersus, Cylindrocopturus fumissi, Dendroctonus spp., for example Dendroctonus ponderosae, Dermestes spp., Diabrotica spp., for example Diabrotica balteata, Diabrotica barberi, Diabrotica speciosa, Diabrotica undecimpunctata howardi, Diabrotica undecimpunctata undecimpunctata, Diabrotica virgifera virgifera, Diabrotica virgifera zeae, Dichocrocis spp., Dicladispa armigera, Diloboderus spp., Disonycha xanthomelas, family Elateridae, Epicaerus spp., Epicauta spp., Epilachna spp., for example Epilachna borealis, Epilachna varivestis, Epitrix spp., for example Epitrix cucumeris, Epitrix fuscula, Epitrix hirtipennis, Epitrix subcrinita, Epitrix tuberis, Faustinus spp., Gibbium psylloides, Gnathocerus comutus, Hellula undalis, Heteronychus arator, Heteronyx spp., Hylamorpha elegans, Hylotrupes bajulus, Hypera postica, Hypomeces squamosus, Hypothenemus spp., for example Hypothenemus hampei, Hypothenemus obscurus, Hypothenemus pubescens, Lachnostema consanguinea, Lasioderma serricome, Latheticus oryzae, Lathridius spp., Lema spp., Leptinotarsa decemlineata, Leucoptera spp., for example Leucoptera coffeella, Limonius ectypus, Lissorhoptrus oryzophilus, Listronotus (=Hyperodes) spp., for example, Listronotus oregonensis, Lixus spp., Luperodes spp., Luperomorpha xanthodera, Lyctus spp., Megacyllene spp., for example Megacyllene robiniae, Megascelis spp., Melanotus spp., for example Melanotus communis, Melanotus longulus oregonensis, Meligethes aeneus, Melolontha spp., for example Melolontha melolontha, Metriona bicolor, Migdolus spp., Monochamus spp., Naupactus xanthographus, Necrobia spp., Neogalerucella spp., Niptus hololeucus, Oryctes rhinoceros, Oryzaephilus surinamensis, Oryzaphagus oryzae, Otiorhynchus spp., for example Otiorhynchus cribricollis, Otiorhynchus ligustici, Otiorhynchus ovatus, Otiorhynchus rugosostriarus, Otiorhynchus sulcatus, Oulema spp., for example Oulema melanopus, Oulema oryzae, Oxycetonia jucunda, Phaedon cochleariae, Phyllophaga spp., Phyllophaga helleri, Phyllotreta spp., for example Phyllotreta armoraciae, Phyllotreta cruciferae, Phyllotreta pusilla, Phyllotreta ramosa, Phyllotreta striolata, Popillia japonica, Premnotrypes spp., Prostephanus truncatus, Psylliodes spp., for example Psylliodes affinis, Psylliodes chrysocephala, Psylliodes punctulata, Ptinus spp., Rhizobius ventralis, Rhizopertha dominica, Rhynchophorus spp., Rhynchophorus ferrugineus, Rhynchophorus palmarum, family Scarabaeidae, Scolytus spp., for example Scolytus multistriatus, Sinoxylon perforans, Sitophilus spp., for example Sitophilus granarius, Sitophilus linearis, Sitophilus oryzae, Sitophilus zeamais, Sphenophorus spp., for example Sphenophorus maidis, Stegobium paniceum, Stemechus spp., for example Stemechus paludatus, Symphyletes spp., Systena spp., Systena blanda, Tanymecus spp., for example Tanymecus dilaticollis, Tanymecus indicus, Tanymecus palliatus, Tenebrio molitor, Tenebrioides mauretanicus, Tribolium spp., for example Tribolium audax, Tribolium castaneum, Tribolium confusum, Trogoderma spp., Tychius spp., Xylotrechus spp., Zabrus spp., for example Zabrus tenebrioides;
from the order of the Dermaptera, for example Anisolabis maritime, Forficula auricularia, Labidura riparia; from the order of the Diptera, for example Aedes spp., for example Aedes aegypti, Aedes albopictus, Aedes sticticus, Aedes vexans, Agromyza spp., for example Agromyza frontella, Agromyza oryzae, Agromyza parvicomis, Anastrepha spp., for example Anastrepha fraterculus, Anastrepha ludens, Anastrepha obliqua, Anopheles spp., for example Anopheles quadrimaculatus, Anopheles gambiae, Asphondylia spp., Bactrocera spp., for example Bactrocera correcta, Bactrocera cucurbitae, Bactrocera dorsalis, Bactrocera oleae, Bactrocera tyroni, Bactrocera zonata, Bibio hortulanus, Calliphora erythrocephala, Calliphora vicina, Ceratitis capitata, Chironomus spp., Chlorops oryzae, Chrysomya spp., Chrysops spp., Chrysozona pluvialis, Cochliomya spp., Contarinia spp., for example Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., for example Culex pipiens, Culex quinquefasciatus, Culicoides spp., Culiseta spp., Cuterebra spp., Dacus oleae, Dasineura spp., for example Dasineura brassicae, Delia spp., for example Delia antiqua, Delia coarctata, Delia florilega, Delia platura, Delia radicum, Dermatobia hominis, Drosophila spp., for example Drosphila melanogaster, Drosophila suzukii, Echinocnemus spp., Euleia heraclei, Fannia spp., Gasterophilus spp., Glossina spp., Haematopota spp., Hydrellia spp., Hydrellia griseola, Hylemya spp., Hippobosca spp., Hypoderma spp., Liriomyza spp., for example Liriomyza brassicae, Liriomyza huidobrensis, Liriomyza sativae, Lucilia spp., for example Lucilia cuprina, Lutzomyia spp., Mansonia spp., Musca spp., for example Musca domestica, Musca domestica vicina, Oestrus spp., Ophiomyia simplex, Oscinella frit, Paratanytarsus spp., Paralauterbomiella subcincta, Pegomya or Pegomyia spp., for example Pegomya betae, Pegomya hyoscyami, Pegomya rubivora, Phlebotomus spp., Phorbia spp., Phormia spp., Phytomyza gymnostoma, Piophila casei, Platyparea poeciloptera, Prodiplosis spp., Psila rosae, Rhagoletis spp., for example Rhagoletis cingulata, Rhagoletis completa, Rhagoletis fausta, Rhagoletis indifferens, Rhagoletis mendax, Rhagoletis pomonella, Sarcophaga spp., Simulium spp., for example Simulium meridionale, Stomoxys spp., Tabanus spp., Tetanops spp., Tipula spp., for example Tipula paludosa, Tipula simplex, Toxotrypana curvicauda, Tritoxa flexa and Zonosemata electa.
from the order of the Hemiptera, for example Acizia spp., for example Acizzia acaciaebaileyanae, Acizzia dodonaeae, Acizzia uncatoides, Acrida turrita, Acyrthosipon spp., for example Acyrthosiphon pisum, Acrogonia spp., Aeneolamia spp., Agonoscena spp., Aleurocanthus spp., Aleyrodes proletella, Aleurolobus barodensis, Aleurothrixus floccosus, Allocaridara malayensis, Amrasca spp., for example Amrasca bigutulla, Amrasca devastans, Anuraphis cardui, Aonidiella spp., for example Aonidiella aurantii, Aonidiella citrina, Aonidiella inomata, Aphanostigma piri, Aphis spp., for example Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis vibumiphila, Arboridia apicalis, Arytainilla spp., Aspidiella spp., Aspidiotus spp., for example Aspidiotus nerii, Atanus spp., Aulacorthum solani, Bemisia spp., for example Bemisia argentifolii, Bemisia tabaci, Blastopsylla occidentalis, Boreioglycaspis melaleucae, Brachycaudus helichrysi, Brachycolus spp., Brevicoryne brassicae, Cacopsylla spp., for example Cacopsylla pyri, Cacopsylla pyricola, Calligypona marginata, Capulinia spp., Cameocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus aonidum, Chrysomphalus ficus, Cicadulina mbila, Coccomytilus halli, Coccus spp., for example Coccus hesperidum, Coccus longulus, Coccus pseudomagnoliarum, Coccus viridis, Cryptomyzus ribis, Cryptoneossa spp., Ctenarytaina spp., Daktulosphaira vitifoliae, Dalbulus spp., Dialeurodes chittendeni, Dialeurodes citri, Diaphorina citri, Diaspis spp., Diuraphis spp., Doralis spp., Draeculacephala spp., Drosicha spp., Dysaphis spp., for example Dysaphis apiifolia, Dysaphis plantaginea, Dysaphis tulipae, Dysmicoccus spp., Empoasca spp., for example Empoasca abrupta, Empoascafabae, Empoasca maligna, Empoasca solana, Empoasca stevensi, Eriosoma spp., for example Eriosoma americanum, Eriosoma lanigerum, Eriosoma pyricola, Erthesina fullo, Erythroneura spp., for example Erythroneura vitis, Eucalyptolyma spp., Euphyllura spp., for example Euphyllura olivina, Euscelis bilobatus, Ferrisia spp., Fiorinia spp., Furcaspis oceanica, Geococcus coffeae, Glycaspis spp., Graphocephala versuta, Heteropsylla cubana, Heteropsylla spinulosa, Homalodisca vitripennis, Hyalopterus arundinis, Hyalopterus pruni, Icerya spp., for example Icerya purchasi, Idiocerus spp., Idioscopus spp., Laodelphax striatellus, Lecanium spp., for example Lecanium comi (=Parthenolecanium comi), Lepidosaphes spp., for example Lepidosaphes ulmi, Lipaphis erysimi, Lopholeucaspis japonica, Lycorma delicatula, Macrosiphum spp., for example Macrosiphum euphorbiae, Macrosiphum lilii, Macrosiphum rosae, Macrostelesfacifrons, Mahanarva spp., Melanaphis sacchari, Metcalfiella spp., Metcalfa pruinosa, Metopolophium dirhodum, Monellia costalis, Monelliopsis pecanis, Myzus spp., for example Myzus ascalonicus, Myzus cerasi, Myzus ligustri, Myzus omatus, Myzus persicae, Myzus nicotianae, Nasonovia ribisnigri, Neomaskellia spp., Nephotettix spp., for example Nephotettix cincticeps, Nephotettix nigropictus, Nephotettix virescens, Nettigoniclla spectra, Nilaparvata lugens, Oncometopia spp., for example Oncometopia orbona, Orthezia praelonga, Oxya chinensis, Pachypsylla spp., Parabemisia myricae, Paratrioza spp., for example Paratrioza cockerelli, Parlatoria spp., for example Parlatoria oleae, Pemphigus spp., for example Pemphigus bursarius, Pemphigus populivenae, Peregrinus maidis, Perkinsiella spp., Phenacoccus spp., for example Phenacoccus madeirensis, Philaenus spumarius, Phloeomyzus passerinii, Phorodon humuli, Phylloxera spp., for example Phylloxera devastatrix, Phylloxera notabilis, Pinnaspis aspidistrae, Planococcus spp., for example Planococcus citri, Prosopidopsylla flava, Protopulvinaria pyriformis, Pseudaulacaspis pentagona, Pseudococcus spp., for example Pseudococcus calceolariae, Pseudococcus comstocki, Pseudococcus longispinus, Pseudococcus maritimus, Pseudococcus vibumi, Psyllopsis spp., Psylla spp., for example Psylla buxi, Psylla mali, Psylla pyri, Pteromalus spp., Pulvinaria spp., Pyrilla spp., Quadraspidiotus spp., for example Quadraspidiotus juglansregiae, Quadraspidiotus ostreaeformis, Quadraspidiotus pemiciosus, Quesada gigas, Rastrococcus spp., Rhopalosiphum spp., for example Rhopalosiphum maidis, Rhopalosiphum oxyacanthae, Rhopalosiphum padi, Rhopalosiphum rufiabdominale, Saissetia spp., for example Saissetia coffeae, Saissetia miranda, Saissetia neglecta, Saissetia oleae, Scaphoideus titanus, Schizaphis graminum, Selenaspidus articulatus, Sipha flava, Sitobion avenae, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., for example Toxoptera aurantii, Toxoptera citricidus, Trialeurodes spp., for example Trialeurodes abutiloneus, Trialeurodes vaporariorum, Trioza spp., for example Trioza diospyri, Typhlocyba spp., Unaspis spp., Viteus vitifolii, Zygina spp.;
from the suborder of the Heteroptera, for example Aelia spp., Anasa tristis, Antestiopsis spp., Boisea spp., Blissus spp., Calocoris spp., Campylomma livida, Cavelerius spp., Chinavia hilaris, Cimex spp., for example Cimex adjunctus, Cimex hemipterus, Cimex lectularius, Cimex pilosellus, Collaria spp., Creontiades dilutus, Dasynus piperis, Dichelops spp., for example Dichelops furcatus, Dichelops melacantus, Diconocoris hewetti, Dysdercus spp., Euschistus spp., for example Euschistus heros, Euschistus servus, Euschistus tristigmus, Euschistus variolarius, Eurydema spp., Eurygaster spp., Halyomorpha halys, Heliopeltis spp., Horcias nobilellus, Leptocorisa spp., Leptocorisa varicomis, Leptoglossus occidentalis, Leptoglossus phyllopus, Lygocoris spp., for example Lygocoris pabulinus, Lygus spp., for example Lygus elisus, Lygus hesperus, Lygus lineolaris, Macropes excavatus, Megacopta cribraria, Miridae, Monalonion atratum, Nezara spp., for example Nezara viridula, Nysius spp., Oebalus spp., for example Oebalus pugnax, family Pentomidae, Piesma quadrata, Piezodorus spp., for example Piezodorus guildinii, Psallus spp., Pseudacysta persea, Rhodnius spp., Sahlbergella singularis, Scaptocoris castanea, Scotinophora spp., Stephanitis nashi, Tibraca spp., Triatoma spp.;
from the order of the Homoptera, for example, Agonoscena spp., Aleurodes spp., Aleurolobus barodensis, Aleurothrixus spp., family Aleyrodidae, Amrasca spp., Anuraphis cardui, Aonidiella spp., Aphanostigma piri, Aphis spp., Arboridia apicalis, Aspidiella spp., Atanus spp., Aulacorthum solani, Brachycaudus helichrysii, Brachycolus spp., Brachycorynella asparagi, Brevicoryne brassicae, Calligypona marginata, Carneocephala fulgida, Ceratovacuna lanigera, Cercopidae, Ceroplastes spp., Chaetosiphon fragaefolu, Chionaspis tegalensis, Chlorita onukii, Chromaphis juglandicola, Chrysomphalus ficus, Cicadulina mbila, Coccomytilus halli, Coccus spp., Cryptomyzus ribis, Dialeurodes spp., Diaphorina spp., Diaspis spp., Doralis spp., Drosicha spp., Dysaphis spp., Dysmicoccus spp., Empoasca spp., Eriosoma spp., Euscelis bilobatus, Geococcus coffeae, Hyalopterus arundinis, leery a spp., Idiocerus spp., Idioscopus spp., Laodelphax striatellus, Lecanium spp., Lepidosaphes spp., Lipaphis erysimi, Macrosiphum spp., Macrosteles quadrilineatus, Mahanarva fimbriolata, Melanaphis sacchari, Metcalfiella spp., Metopolophium dirhodum, Monellia costalis, Monelliopsis pecanis, Myzus spp., Nasonovia ribisnigri, spp., Orthezia praelonga, Parabemisia myricae, Paratrioza spp., Pemphigus spp., Peregrinus maidis, Phenacoccus spp., Phloeomyzus passerinii, Phorodon humuli, Phylloxera spp., Pinnaspis aspidistrae, Planococcus spp., for example, Planococcus citri, Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Schizaphis graminum, Selenaspidus articulatus, Sogata spp., Sogatodes spp., Spissistilus festifnus, Stictocephalafestina, Tenalaphara malayensis, Tinocallis caryaefoliae, Tomaspis spp., Toxoptera spp., Trioza spp., Typhlocyba spp., Unaspis spp., Viteus vitifolii;
from the order of the Hymenoptera, for example Acromyrmex spp., Athalia spp., for example Athalia rosae, Atta spp., Camponotus spp., Dolichovespula spp., Diprion spp., for example Diprion similis, Hoplocampa spp., for example Hoplocampa cookei, Hoplocampa testudinea, Lasius spp., Linepithema (Iridiomyrmex) humile, Monomorium pharaonis, Paratrechina spp., Paravespula spp., Plagiolepis spp., Sirex spp., for example Sirex noctilio, Solenopsis invicta, Tapinoma spp., Technomyrmex albipes, Urocerus spp., Vespa spp., for example Vespa crabro, Wasmannia auropunctata, Xeris spp.; from the order of the Isopoda, for example Armadillidium vulgare, Oniscus asellus, Porcellio scaber; from the order of the Isoptera, for example Coptotermes spp., for example Coptotermes formosanus, Comitermes cumulans, Cryptotermes spp., Incisitermes spp., Kalotermes spp., Microtermes obesi, Nasutitermes spp., Odontotermes spp., Porotermes spp., Reticulitermes spp., for example Reticulitermes flavipes, Reticulitermes hesperus;
from the order of the Lepidoptera, for example Achroia grisella, Acronicta major, Adoxophyes spp., for example Adoxophyes orana, Aedia leucomelas, Agrotis spp., for example Agrotis c-nigrum, Agrotis ipsilon, Agrotis segetum, Alabama spp., for example Alabama argillacea, Amyelois transitella, Anarsia spp., Anticarsia spp., for example Anticarsia gemmatalis, Argyroploce spp., Autographa spp., Barathra brassicae, Blastodacna atra, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., for example Chilo plejadellus, Chilo suppressalis, Choreutis pariana, Choristoneura spp., Chrysodeixis chalcites, Clysia ambiguella, Cnaphalocerus spp., Cnaphalocrocis medinalis, Cnephasia spp., Colias eurytheme, Conopomorpha spp., Conotrachelus spp., Copitarsia spp., Cydia spp., for example Cydia nigricana, Cydia pomonella, Dalaca noctuides, Diaphania spp., Diparopsis spp., Diatraea saccharalis, Dioryctria spp., for example Dioryctria zimmermani, Earias spp., Ecdytolopha aurantium, Elasmopalpus lignosellus, Eldana saccharina, Ephestia spp., for example Ephestia elutella, Ephestia kuehniella, Epinotia spp., Epiphyas postvittana, Erannis spp., Erschoviella musculana, Etiella spp., Eudocima spp., Eulia spp., Eupoecilia ambiguella, Euproctis spp., for example Euproctis chrysorrhoea, Euxoa spp., Euzophera semifuneralis, Evergestos rimosalis, Feltia spp., Galleria mellonella, Gracillaria spp., Grapholitha spp., for example Grapholita molesta, Grapholita prunivora, Hedylepta spp., Helicoverpa spp., for example Helicoverpa armigera, Helicoverpa zea, Heliothis spp., for example Heliothis virescens, Hoffnannophila pseudospretella, Homoeosoma spp., Homona spp., Hyponomeuta padella, Kakivoria flavofasciata, Lampides spp., Laphygma spp., Laspeyresia molesta, Leucinodes orbonalis, Leucoptera spp., for example Leucoptera coffeella, Lithocolletis spp., for example Lithocolletis blancardella, Lithophane antennata, Lobesia spp., for example Lobesia botrana, Loxagrotis albicosta, Lymantria spp., for example Lymantria dispar, Lyonetia spp., for example Lyonetia clerkella, Malacosoma neustria, Mamestra brassicae, Manduca spp., for example, Manduca sexta, Manduca quinquemaculata, Maruca testulalis, Melanitis leda, Melittia cucurbitae, Mocis spp., Monopis obviella, Mythimna separata, Nemapogon cloacellus, family Noctuidae, Nymphula spp., Oiketicus spp., Omphisa spp., Operophtera spp., Oria spp., Orthaga spp., Ostrinia spp., for example Ostrinia nubilalis, Panolis flammea, Pamara spp., Paralobesia viteana, Pectinophora spp., for example Pectinophora gossypiella, Peridroma saucia, Perileucoptera spp., Phthorimaea spp., for example Phthorimaea operculella, Phyllocnistis citrella, Phyllonorycter spp., for example Phyllonorycter blancardella, Phyllonorycter crataegella, Pieris spp., for example Pieris rapae, Plathypena scabra, Platynota stultana, Plodia interpunctella, Plusia spp., Plutella xylostella (=Plutella maculipennis), Podesia spp., for example Podesia syringae, Prays spp., Prodenia spp., Protoparce spp., Pseudaletia spp., for example Pseudaletia unipuncta, Pseudoplusia includens, Ptorimaea operculella, Pyrausta nubilalis, Rachiplusia nu, Schoenobius spp., for example Schoenobius bipunctifer, Scirpophaga spp., for example Scirpophaga incertulas, Scirpophaga innotata, Scotia segetum, Sesamia spp., for example Sesamia inferens, Sparganothis spp., Spodoptera spp., for example Spodoptera eradiana, Spodoptera exigua, Spodoptera frugiperda and Spodoptera praefica, Stathmopoda spp., Stenoma spp., Stomopteryx subsecivella, Striacosta albicosta, Synanthedon spp., Tecia solanivora, Thaumetopoea spp., Thermesia gemmatalis, Tinea cloacella, Tinea pellionella, Tineola bisselliella, Tortrix spp., for example Tortrix velutinana, Trichophaga tapetzella, Trichoplusia spp., for example Trichoplusia ni, Tryporyza incertulas, Tuta absoluta, Virachola spp.;
from the order of the Orthoptera or Saltatoria, for example Acheta domesticus, Dichroplus spp., Gryllotalpa spp., for example Gryllotalpa gryllotalpa, Hieroglyphus spp., Locusta spp., for example Locusta migratoria, Melanoplus spp., for example Melanoplus devastator, Melanoplus differentialis, Melanoplus femurrubrum, Paratlanticus ussuriensis, Schistocerca gregaria;
from the order of the Phthiraptera, for example Damalinia spp., Haematopinus spp., Linognathus spp., Pediculus spp., Phylloxera vastatrix, Phthirus pubis, Trichodectes spp.;
from the order of the Psocoptera, for example Lepinotus spp., Liposcelis spp.;
from the order of the Siphonaptera, for example, Ceratophyllus spp., Ctenocephalides spp., for example Ctenocephalides canis, Ctenocephalides felis, Pulex irritans, Tunga penetrans, Xenopsylla cheopis; from the order of the Thysanoptera, for example Anaphothrips obscurus, Baliothrips biformis, Chaetanaphothrips leeuweni, Drepanothrips reuteri, Enneothrips flavens, Frankliniella spp., for example Frankliniella fusca, Frankliniella occidentalis, Frankliniella schultzei, Frankliniella tritici, Frankliniella vaccinii, Frankliniella williamsi, Haplothrips spp., Heliothrips spp., Hercinothrips femoralis, Kakothrips spp., Rhipiphorothrips cruentatus, Scirtothrips spp., Taeniothrips cardamomi, Thrips spp., for example Thrips palmi, Thrips tabaci;
from the order of the Zygentoma (=Thysanura), for example Ctenolepisma spp., Fepisma saccharina, Fepismodes inquilinus, Thermobia domestica;
from the class of the Symphyla, for example Scutigerella spp., for example Scutigerella immaculata; pests from the phylum of the Mollusca, for example from the class of the Bivalvia, for example Dreissena spp., and also from the class of the Gastropoda, for example Arion spp., for example Arion ater ruftis, Biomphalaria spp., Bulinus spp., Deroceras spp., for example Deroceras laeve, Galba spp., Fymnaea spp., Oncomelania spp., Pomacea spp., Succinea spp.;
plant pests from the phylum of the Nematoda, i.e., phytoparasitic nematodes, in particular Aglenchus spp., for example Aglenchus agricola, Anguina spp., for example Anguina tritici, Aphelenchoides spp., for example Aphelenchoides arachidis, Aphelenchoides fragariae, Belonolaimus spp., for example Belonolaimus gracilis, Belonolaimus longicaudatus, Belonolaimus nortoni, Bursaphelenchus spp., for example Bursaphelenchus cocophilus, Bursaphelenchus eremus, Bursaphelenchus xylophilus, Cacopaurus spp., for example Cacopaurus pestis, Criconemella spp., for example Criconemella curvata, Criconemella onoensis, Criconemella omata, Criconemella rusium, Criconemella xenoplax (=Mesocriconema xenoplax), Criconemoides spp., for example Criconemoides femiae, Criconemoides onoense, Criconemoides omatum, Ditylenchus spp., for example Ditylenchus dipsaci, Dolichodorus spp., Globodera spp., for example Globodera pallida, Globodera rostochiensis, Helicotylenchus spp., for example Helicotylenchus dihystera, Hemicriconemoides spp., Hemicycliophora spp., Heterodera spp., for example Heterodera avenae, Heterodera glycines, Heterodera schachtii, Hirschmaniella spp., Hoplolaimus spp., Longidorus spp., for example Longidorus africanus, Meloidogyne spp., for example Meloidogyne chitwoodi, Meloidogyne fallax, Meloidogyne hapla, Meloidogyne incognita, Meloinema spp., Nacobbus spp., Neotylenchus spp., Paralongidorus spp., Paraphelenchus spp., Paratrichodorus spp., for example Paratrichodorus minor, Paratylenchus spp., Pratylenchus spp., for example Pratylenchus penetrans, Pseudohalenchus spp., Psilenchus spp., Punctodera spp., Quinisulcius spp., Radopholus spp., for example Radopholus citrophilus, Radopholus similis, Rotylenchulus spp., Rotylenchus spp., Scutellonema spp., Subanguina spp., Trichodorus spp., for example Trichodorus obtusus, Trichodorus primitivus, Tylenchorhynchus spp., for example Tylenchorhynchus annulatus, Tylenchulus spp., for example Tylenchulus semipenetrans, Xiphinema spp., for example Xiphinema index.

Preferably, the compositions of the present invention are effective against Tetranychus urticae, Acalymma vittatum, Cerotoma trifurcata, Crioceris asparagi, Crioceris duodecimpunctata, Diabrotica spp., for example, Diabrotica speciosa, Diabrotica undecimpunctata howardi, Disonycha xanthomelas, family Elateridae, Epicauta spp., Epilachna varivestis, Epitrix spp., for example Epitrix cucumeris, Epitrix fuscula, Leptinotarsa decemlineata, Listronotus oregonensis, Metriona bicolor, Phyllotreta cruciferae, Phyllotreta striolata, family Scarabaeidae, Systena spp., Systena blanda, Delia antiqua, Delia platura, Delia radicum, Liriomyza sativae, Ophiomyia simplex, Pegomya hyoscyami, Phytomyza gymnostoma, Tritoxa flexa, Acyrthosiphon pisum, Aphis spp., for example, Aphis fabae, Aphis gossypii, Brevicoryne brassicae, Empoasca fabae, Erthesina fullo, Lipaphis erysimi, Macrosiphum euphorbiae, Myzus persicae, Anasa tristis, Halyomorpha halys, Lygus lineolaris, family Pentomidae, family Aleyrodidae, Brachycorynella asparagi, Macrosteles quadrilineatus, Agrotis ipsilon, Colias eurytheme, Evergestos rimosalis, Helicoverpa zea, Manduca spp., for example, Manduca sexta, Manduca quinquemaculata, Melittia cucurbitae, family Noctuidae, Ostrinia nubilalis, Peridroma saucia, Pieris rapae, Plathypena scabra, Plutella xylostella (=Plutella maculipennis), Ptorimaea operculella, Spodoptera spp., for example, Spodoptera exigua, Spodoptera frugiperda, Trichoplusia ni, Tuta absoluta, Frankliniella tritici and Thrips tabaci.

In one embodiment, the vegetable plant is selected from Solanum lycopersicum, preferably tomato, Capsicum annuum, preferably pepper, bell pepper and sweet pepper or Solanum melongena, preferably, eggplant, and the plant pest comprises at least one member selected from the group consisting of Tetranychus urticae, Diabrotica speciosa, Epitrix cucumeris, Epitrix fuscula, Leptinotarsa decemlineata, Systena blanda, Erthesina fullo, Macrosiphum euphorbiae, Myzus persicae, Halyomorpha halys, Lygus lineolaris, family Pentomidae, family Aleyrodidae, Helicoverpa zea, Manduca sexta, Manduca quinquemaculata, Ostrinia nubilalis, Peridroma saucia, Spodoptera exigua, Spodoptera frugiperda and Tuta absoluta.

In one embodiment, the vegetable plant is selected from Phaseolus spp., Viciafaba or Pisum sativum and the plant pest comprises at least one member selected from the group consisting of Tetranychus urticae, Cerotoma trifurcata, Diabrotica speciosa, Epilachna varivestis, Delia platura, Acyrthosiphon pisum, Aphis fabae, Empoasca fabae, Erthesina fullo, Halyomorpha halys, Colias eurytheme, Helicoverpa zea, Ostrinia nubilalis and Plathypena scabra.

In one embodiment, the vegetable plant is Brassica oleracea and the plant pest comprises at least one member selected from the group consisting of Diabrotica speciosa, Phyllotreta cruciferae, Phyllotreta striolata, Delia radicum, Brevicoryne brassicae, Erthesina fullo, Lipaphis erysimi, Myzus persicae, Halyomorpha halys, Evergestos rimosalis, Pieris rapae, Plutella xylostella (=Plutella maculipennis), Spodoptera frugiperda, Trichoplusia ni, Frankliniella tritici and Thrips tabaci.

In one embodiment, the vegetable plant is Cucurbita spp. and the plant pest comprises at least one member selected from the group consisting of Tetranychus urticae, Acalymma vittatum, Diabrotica speciosa, Diabrotica undecimpunctata howardi, Aphis gossypii, Erthesina fullo, Anasa tristis, Melittia cucurbitae and Trichoplusia ni.

In one embodiment, the vegetable plant is selected from Ipomoea batatas, preferably sweet potato, Asparagus officinalis, preferably asparagus, and Allium cepa, preferably, onion, and the plant pest comprises at least one member selected from the group consisting of Crioceris asparagi, Crioceris duodecimpunctata, Diabrotica speciosa, Diabrotica undecimpunctata howardi, family Elateridae, Metriona bicolor, family Scarabaeidae, Systena spp., Systena blanda, Delia antiqua, Erthesina fullo, Ophiomyia simplex, Phytomyza gymnostoma, Tritoxa flexa, Brachycorynella asparagi, Agrotis ipsilon, family Noctuidae and Thrips tabaci.

In one embodiment, the vegetable plant is selected from Spinacia oleracea, preferably spinach, Lactuca sativa, preferably lettuce, and Daucus carota, preferably carrots, and the plant pest comprises at least one member selected from the group consisting of Diabrotica speciosa, Diabrotica undecimpunctata howardi, Disonycha xanthomelas, Listronotus oregonensis, Systena blanda, Liriomyza sativae, Pegomya hyoscyami, Erthesina fullo, Myzus persicae, Lygus lineolaris, Macrosteles quadrilineatus, Helicoverpa zea, family Noctuidae, Spodoptera exigua, and Trichoplusia ni.

In one embodiment, the vegetable plant is Solanum tuberosum, preferably potato, and the plant pest comprises at least one member selected from the group consisting of Tetranychus urticae, Diabrotica speciosa, family Elateridae, Epicauta spp., Epitrix spp., Leptinotarsa decemlineata, Delia platura, Empoasca fabae, Erthesina fullo, Macrosiphum euphorbiae, Myzus persicae, Agrotis ipsilon, Manduca spp. and Ptorimaea operculella.

The compositions of the present invention comprise pelargonic acid, a liquid or solid carrier and, optionally, one or more customary formulation auxiliaries, which may be liquid or solid, for example surfactants, antifoams, for example silicone oil, preservatives, clays, inorganic compounds, viscosity regulators, binders and/or tackifiers. The composition may also further comprise a fertilizer, a micronutrient donor or other preparations which influence the growth of plants.

Preferably, the pelargonic acid compositions are foliarly applied to the vegetable plants. Examples of foliar formulation types for pre-mix compositions are GR: Granules; WP: wettable powders; WG: water dispersable granules (powders); SG: water soluble granules; SL: soluble concentrates; EC: emulsifiable concentrate; EW: emulsions, oil in water; ME: micro-emulsion; SC: aqueous suspension concentrate; CS: aqueous capsule suspension; OD: oil-based suspension concentrate, and SE: aqueous suspo-emulsion. The type of pelargonic acid composition is to be selected to suit the intended aims and the prevailing circumstances.

The formulation components that are suitable for the preparation of the compositions according to the invention are known per se.

As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, α,α-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surfactants can advantageously be used in both liquid and solid formulations, especially in those formulations which can be diluted with a carrier prior to use. Surfactants may be anionic, cationic, non-ionic or polymeric and they can be used as emulsifiers, wetting agents or suspending agents or for other purposes. Typical surfactants include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; siloxanes, silicones, silanes, silicates and siliconates; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; esters of stearate and also further substances described e.g. in McCutcheon's Detergents and Emulsifiers Annual, MC Publishing Corp., Ridgewood New Jersey (1981).

The compositions according to the invention can include an additive comprising an oil of vegetable or animal origin, a mineral oil, alkyl esters of such oils or mixtures of such oils and oil derivatives. The amount of oil additive, when present, in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10th Edition, Southern Illinois University, 2010.

As with the nature of the formulations, the methods of application, such as foliar, drench, spraying, atomizing, dusting, scattering, coating or pouring, are chosen in accordance with the intended objectives and the prevailing circumstances.

Whereas commercial products will preferably be formulated as concentrates (e.g., pre-mix or ready-mix compositions), the end user will normally employ dilute formulations (e.g., spray mix, spray tank or tank-mix (when combined with other pesticides or formulation auxiliaries) compositions).

Generally, the pre-mix compositions comprise 0.1 to 99%, especially 15 to 90%, of pelargonic acid and 0 to 99.9% of at least one liquid or solid carrier, and 0 to 35%, especially 0.1 to 20%, of the composition to be formulation auxiliaries, e.g., surfactants (% in each case meaning percent by weight in the pre-mix composition).

Generally, a spray mix or spray tank formulation for foliar or soil application comprises 0.05 to 20%, especially 0.1 to 15%, of pelargonic acid, and 99.95 to 80%, especially 99.9 to 85%, of a liquid carrier, and 0 to 20%, especially 0.1 to 15%, of formulation auxiliaries, e.g., surfactants (% in each case meaning percent by weight in the tank-mix composition).

The rates of application (grams of pelargonic acid/hectare or g/ha) vary and depend on the method of application, the crop plant, the pest to be controlled, the prevailing climatic conditions, and other factors governed by the method of application, the time of application and the target crop. For foliar application, sprayable mixtures of the pelargonic acid compositions are prepared at a concentration that, when applied at a given spray rate, delivers pelargonic acid to the plants in an amount of from 300 to 6,500 g/ha, preferably 450 to 4,500 g/ha.

For example, preferably the pelargonic acid composition is applied at a dilution containing pelargonic acid at less than about 6,500 g/ha, preferably less than about 4500 g/ha, most preferably about 1300 g/ha. In preferred aspects, the compositions of the present proposals are provided at a dilution containing the pelargonic acid at between about 300 and about 6,500 g/ha, preferably between about 450 and about 4,500 g/ha, most preferably between about 500 and about 1,300 g/ha. At higher concentrations, phytotoxicity, e.g., leaf scorching, becomes more prevalent, e.g., above about 10,000 g/ha of pelargonic acid. At lower concentrations, e.g., below about 300 g/ha of pelargonic acid, the arthropodicidal, e.g., insecticidal and acaricidal, effectiveness decreases when used alone.

The present compositions have been demonstrated to have low phytotoxicity, e.g., exhibiting zero or acceptable leaf scorching, at rates of e.g., 1,300 g/ha or even up to 4,500 g/ha of pelargonic acid depending on the crop and its growth stage.

Methods of using the present compositions for controlling arthropod, preferably insect and/or acari, pests on vegetable plants are also part of the present invention. For example, the compositions are preferably used at a dilution, e.g., those dilutions preferred above, to provide effective insecticidal/acaricidal properties coupled with low phytotoxicity. In preferred aspects, these methods relate to the killing of specific pests such as insects and acari selected from Tetranychus urticae, Acalymma vittatum, Cerotoma trifurcata, Crioceris asparagi, Crioceris duodecimpunctata, Diabrotica spp., for example, Diabrotica speciosa, Diabrotica undecimpunctata howardi, Disonycha xanthomelas, family Elateridae, Epicauta spp., Epilachna varivestis, Epitrix spp., for example Epitrix cucumeris, Epitrix fuscula, Leptinotarsa decemlineata, Listronotus oregonensis, Metriona bicolor, Phyllotreta cruciferae, Phyllotreta striolata, family Scarabaeidae, Systena spp., Systena blanda, Delia antiqua, Delia platura, Delia radicum, Liriomyza sativae, Ophiomyia simplex, Pegomya hyoscyami, Phytomyza gymnostoma, Tritoxa flexa, Acyrthosiphon pisum, Aphis spp., for example, Aphis fabae, Aphis gossypii, Brevicoryne brassicae, Empoasca fabae, Erthesina fullo, Lipaphis erysimi, Macrosiphum euphorbiae, Myzus persicae, Anasa tristis, Halyomorpha halys, Lygus lineolaris, family Pentomidae, family Aleyrodidae, Brachycorynella asparagi, Macrosteles quadrilineatus, Agrotis ipsilon, Colias eurytheme, Evergestos rimosalis, Helicoverpa zea, Manduca spp., for example, Manduca sexta, Manduca quinquemaculata, Melittia cucurbitae, family Noctuidae, Ostrinia nubilalis, Peridroma saucia, Pieris rapae, Plathypena scabra, Plutella xylostella (=Plutella maculipennis), Ptorimaea operculella, Spodoptera spp., for example, Spodoptera exigua, Spodoptera frugiperda, Trichoplusia ni, Tuta absoluta, Frankliniella tritici and Thrips tabaci.

Embodiment A relates to a method of controlling arthropod pests, preferably insect and/or acari pests, on vegetable plants, which comprises applying a pesticidally effective amount of pelargonic acid to a pest, to a locus of a pest, or to a plant susceptible to attack by a pest.

Embodiment B relates to a method for controlling and/or preventing damage by infestation of arthropod pests, preferably insect and/or acari pests, on vegetable plants, which comprises applying a pesticidally effective amount of pelargonic acid to a plant.

Embodiment C relates to the use of pelargonic acid on vegetable plants for controlling and/or or preventing damage by infestation of arthropod pests, preferably insect and/or acari pests.

Embodiment D relates to the use of pelargonic acid in the manufacture of an arthropodicide for controlling and/or or preventing damage to vegetable plants by infestation of arthropod pests, preferably insect and/or acari pests.

Embodiment E relates to an arthropodicidal composition for the control of arthropod pests on vegetable plants, comprising pelargonic acid.

In preferred embodiments of A to E, the vegetable plant is selected from Solanum lycopersicum, preferably tomato, Capsicum annuum, preferably pepper, bell pepper and sweet pepper or Solanum melongena, preferably, eggplant, and the arthropod pest is selected from Tetranychus urticae, Diabrotica speciosa, Epitrix cucumeris, Epitrix fuscula, Leptinotarsa decemlineata, Systena blanda, Erthesina fullo, Macrosiphum euphorbiae, Myzus persicae, Halyomorpha halys, Lygus lineolaris, family Pentomidae, family Aleyrodidae, Helicoverpa zea, Manduca sexta, Manduca quinquemaculata, Ostrinia nubilalis, Peridromasaucia, Spodoptera exigua, Spodoptera frugiperda and Tuta absoluta. Preferably, the vegetable plant is tomato and the arthropod pest is selected from Leptinotarsa decemlineata, Halyomorpha halys, Spodoptera exigua, and Tuta absoluta.

In one of Embodiments A to E, the vegetable plant is selected from Phaseolus spp., Viciafaba or Pisum sativum and the arthropod pest is selected from Tetranychus urticae, Cerotoma trifurcata, Diabrotica speciosa, Epilachna varivestis, Delia platura, Acyrthosiphon pisum, Aphis fabae, Empoasca fabae, Erthesina fullo, Halyomorpha halys, Colias eurytheme, Helicoverpa zea, Ostrinia nubilalis and Plathypena scabra. Preferably, the arthropod pest is selected from Diabrotica speciosa, Acyrthosiphon pisum, Aphis fabae and Halyomorpha halys.

In one of Embodiments A to E, the vegetable plant is Brassica oleracea and the arthropod pest is selected from Diabrotica speciosa, Phyllotreta cruciferae, Phyllotreta striolata, Delia radicum, Brevicoryne brassicae, Erthesina fullo, Lipaphis erysimi, Myzus persicae, Halyomorpha halys, Evergestos rimosalis, Pieris rapae, Plutella xylostella (=Plutella maculipennis), Spodoptera frugiperda, Trichoplusia ni, Frankliniella tritici and Thrips tabaci.

In one of Embodiments A to E, the vegetable plant is Cucurbita spp. and the arthropod pest is selected from Tetranychus urticae, Acalymma vittatum, Diabrotica speciosa, Diabrotica undecimpunctata howardi, Aphis gossypii, Erthesina fullo, Anasa tristis, Melittia cucurbitae and Trichoplusia ni.

In one of Embodiments A to E, the vegetable plant is selected from Ipomoea batatas, preferably sweet potato, Asparagus officinalis, preferably asparagus, and Allium cepa, preferably, onion, and the arthropod pest is selected from Crioceris asparagi, Crioceris duodecimpunctata, Diabrotica speciosa, Diabrotica undecimpunctata howardi, family Elateridae, Metriona bicolor, family Scarabaeidae, Systena spp., Systena blanda, Delia antiqua, Erthesina fullo, Ophiomyia simplex, Phytomyza gymnostoma, Tritoxa flexa, Brachycorynella asparagi, Agrotis ipsilon, family Noctuidae and Thrips tabaci.

In one of Embodiments A to E, the vegetable plant is selected from Spinacia oleracea, preferably spinach, Lactuca sativa, preferably lettuce, and Daucus carota, preferably carrots, and the arthropod pest is selected from Diabrotica speciosa, Diabrotica undecimpunctata howardi, Disonycha xanthomelas, Listronotus oregonensis, Systena blanda, Liriomyza sativae, Pegomya hyoscyami, Erthesina fullo, Myzus persicae, Lygus lineolaris, Macrosteles quadrilineatus, Helicoverpa zea, family Noctuidae, Spodoptera exigua, and Trichoplusia ni.

In one of Embodiments A to E, the vegetable plant is Solanum tuberosum, preferably potato, and the arthropod pest is selected from Tetranychus urticae, Diabrotica speciosa, family Elateridae, Epicauta spp., Epitrix spp., Leptinotarsa decemlineata, Delia platura, Empoasca fabae, Erthesina fullo, Macrosiphum euphorbiae, Myzus persicae, Agrotis ipsilon, Manduca spp. and Ptorimaea operculella. Preferably, the pest is selected from Diabrotica speciosa, Leptinotarsa decemlineata and Myzus persicae.

Other embodiments of the present invention relate to the use of pelargonic acid, or derivatives thereof, for controlling or preventing damage of useful plants by Aphis spp., and to methods for controlling or preventing damage of useful plants by Aphis spp., comprising applying pelargonic acid, or derivatives thereof, in a pesticidally effective amount to the useful plants, preferably when the Aphis spp. are present, wherein the useful plants are selected from Cucurbita spp., Phaseolus spp., Viciafaba and Pisum sativum. Aphis spp. include Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola and Aphis vibumiphila. Preferably, Aphis spp. is Aphis fabae or Aphis gossypii.

Other embodiments of the present invention relate to the use of pelargonic acid, or derivatives thereof, for controlling or preventing damage of useful plants by Diabrotica spp., and to methods for controlling or preventing damage of useful plants by Diabrotica spp., comprising applying pelargonic acid, or derivatives thereof, in a pesticidally effective amount to the useful plants, preferably when the Diabrotica spp. are present, wherein the useful plants are selected from Solanum lycopersicum, preferably tomato, Capsicum annuum, preferably pepper, bell pepper and sweet pepper or Solanum melongena, preferably, eggplant, Phaseolus spp., Viciafaba or Pisum sativum, Brassica oleracea, Cucurbita spp., Ipomoea batatas, preferably sweet potato, Asparagus officinalis, preferably asparagus, and Allium cepa, preferably, onion, Spinacia oleracea, preferably spinach, Lactuca sativa, preferably lettuce, and Daucus carota, preferably carrots, Solanum tuberosum, preferably potato.

Other embodiments of the present invention relate to the use of pelargonic acid, or derivatives thereof, for controlling or preventing damage of useful plants by Spodoptera spp., and to methods for controlling or preventing damage of useful plants by Spodoptera spp., comprising applying pelargonic acid, or derivatives thereof, in a pesticidally effective amount to the useful plants, preferably when the Spodoptera spp. are present, wherein the useful plants are selected from Solanum lycopersicum, preferably tomato, Capsicum annuum, preferably pepper, bell pepper and sweet pepper, Solanum melongena, preferably, eggplant, Brassica oleracea, Spinacia oleracea, Lactuca sativa and Daucus carota. Spodoptera spp. include Spodoptera eradiana, Spodoptera exigua, Spodoptera frugiperda and Spodoptera praefica. Preferably, Spodoptera spp. is Spodoptera exigua or Spodoptera frugiperda.

Other embodiments of the present invention relate to the use of pelargonic acid, or derivatives thereof, for controlling or preventing damage of useful plants by Tetranychus urticae, and to methods for controlling or preventing damage of useful plants by Tetranychus urticae, comprising applying pelargonic acid, or derivatives thereof, in a pesticidally effective amount to the useful plants, preferably when the Tetranychus urticae are present, wherein the useful plants are selected from Solanum lycopersicum, preferably tomato, Capsicum annuum, preferably pepper, bell pepper and sweet pepper, Solanum melongena, preferably, eggplant, Phaseolus spp., Vicia faba, Pisum sativum, Cucurbita spp., and Solanum tuberosum, preferably potato.

Other embodiments of the present invention relate to the use of pelargonic acid, or derivatives thereof, for controlling or preventing damage of useful plants by Leptinotarsa decemlineata, and to methods for controlling or preventing damage of useful plants by Leptinotarsa decemlineata, comprising applying pelargonic acid, or derivatives thereof, in a pesticidally effective amount to the useful plants, preferably when the Leptinotarsa decemlineata are present, wherein the useful plants are selected from Solanum lycopersicum, preferably tomato, Capsicum annuum, preferably pepper, bell pepper and sweet pepper, Solanum melongena, preferably, eggplant, and Solanum tuberosum, preferably potato.

Other embodiments of the present invention relate to the use of pelargonic acid, or derivatives thereof, for controlling or preventing damage of useful plants by Myzus persicae, and to methods for controlling or preventing damage of useful plants by Myzus persicae, comprising applying pelargonic acid, or derivatives thereof, in a pesticidally effective amount to the useful plants, preferably when the Myzus persicae are present, wherein the useful plants are selected from Solanum lycopersicum, preferably tomato, Capsicum annuum, preferably pepper, bell pepper and sweet pepper, Solanum melongena, preferably, eggplant, Brassica oleracea, Spinacia oleracea, preferably spinach, Lactuca sativa, preferably lettuce, Daucus carota, preferably carrots, and Solanum tuberosum, preferably potato.

One embodiment of the present invention relates to a method for growing vegetable plants comprising applying or treating the vegetable plants thereof with a pelargonic acid composition.

The activity of the compositions according to the invention can be broadened considerably, and adapted to prevailing circumstances, by adding additional pesticidally active agents to the pelargonic acid compositions. Compositions comprising combinations of (A) pelargonic acid and (B) at least one additional pesticidally active agent (i.e., other than pelargonic acid) may also have further surprising advantages which can also be described, in a wider sense, as super-additive (“synergistic”) effects. Thus, for example, by using or employing the compositions in the treatments as set forth herein, reduced application rates and/or a widening of the activity spectrum and/or an increase in the activity better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

One embodiment relates to compositions comprising (A) pelargonic acid and (B) at least on additional pesticidally active agent, as well as the use of the compositions of (A) and (B) in the methods and uses as set forth herein.

One embodiment relates to combinations comprising (A) pelargonic acid and (B) at least on additional pesticidally active agent, as well as the use of the combinations of (A) and (B) in the methods and uses as set forth herein.

One embodiment relates to a method for reducing overall damage of vegetable plants and vegetable plant parts caused by arthropod pests, preferably insect and/or acari pests, comprising the step of applying (A) pelargonic acid alone or in combination with (B) at least one additional pesticidally active agent, as defined herein, to a plant.

One embodiment relates to a method for increasing crop yield and/or the quality of food commodities from vegetable plants comprising the step of applying (A) pelargonic acid alone or in combination with (B) at least one additional pesticidally active agent, as defined herein to a plant.

As used herein, the expression “combination” stands for the various combinations of (A) pelargonic acid and (B) the at least one pesticidally active agent, for example in a single “ready-mix” or “pre-mix” form, in a combined spray mixture composed from separate formulations of the single active compounds, such as a “tank-mix”, and in a combined use of the single active ingredients when applied in a sequential manner, i.e., one after the other within a reasonably short period, such as a few hours or days, e.g.; 2 hours to 7 days. Preferably, the order of applying the pelargonic acid and the at least one pesticidally active agent is not essential for working the present invention. Accordingly, the term “combination” also encompasses the presence of pelargonic acid composition and the at least one pesticidally active agent on a plant that has been treated.

The ratio of (A) pelargonic acid and (B) any additional pesticidally active agents is selected such that, when applied to the vegetable plants, the pelargonic acid and the pesticidally active agents are delivered at their respective desired rates, e.g., as taught on a product label or as can be determined by one experienced in the field, required for pest control. Because the application rates for the additional pesticidally active agents can vary greatly from one another, the general ratios of pelargonic acid to the additional active agent also can vary greatly. The compositions comprising mixtures of pelargonic acid with additional pesticidally active agents described above comprise pelargonic acid and an active agent as described above preferably in a mixing ratio of from 1000:1 to 1:1, preferably in a weight ratio of 700:1 to 10:1, more preferably in a weight ratio of 500:1 to 30:1, and most preferably in a weight ratio of 100:1 to 1:100.

Suitable additional pesticidally active agents here are, for example, representatives of the following classes of active ingredients:
(1) Acetylcholinesterase (AChE) inhibitors,
(2) GABA-gated chloride channel blockers,
(3) Sodium channel modulators,
(4) Nicotinic acetylcholine receptor (nAChR) competitive modulators, (5) Nicotinic acetylcholine receptor (nAChR) allosteric modulators,
(6) Glutamate-gated chloride channel (GIuCI) allosteric modulators,
(7) Juvenile hormone mimics,
(8) Miscellaneous non-specific (multi-site) inhibitors,
(9) Chordotonal organ TRPV channel modulators,
(10) Mite growth inhibitors,
(11) Microbial disrupters of the insect gut membrane,
(12) Inhibitors of mitochondrial ATP synthase,
(13) Uncouplers of oxidative phosphorylation via disruption of the proton gradient,
(14) Nicotinic acetylcholine receptor channel blockers
(15) Inhibitors of chitin biosynthesis, type 0
(16) Inhibitors of chitin biosynthesis, type 1
(17) Moulting disrupters
(18) Ecdysone receptor agonists
(19) Octopamine receptor agonists
(20) Mitochondrial complex III electron transport inhibitors
(21) Mitochondrial complex I electron transport inhibitors
(22) Voltage-dependent sodium channel blockers
(23) Inhibitors of acetyl CoA carboxylase
(24) Mitochondrial complex IV electron transport inhibitors
(25) Mitochondrial complex II electron transport inhibitors
(26) Ryanodine receptor modulators
(27) Chordotonal organ modulators and
(28) further pesticidally active compounds.

In a preferred embodiment, said pesticidally active agent is selected from the group consisting of (1) Acetylcholinesterase (AChE) inhibitors which are carbamates and preferably selected from alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb, or organophosphates, preferably selected from acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion;
(2) GABA-gated chloride channel blockers which are cyclodiene-organochlorines and preferably selected from chlordane and endosulfan, or phenylpyrazoles (fiproles) and preferably selected from ethiprole and fipronil;
(3) Sodium channel modulators which are pyrethroids and preferably selected from acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(IR)-trans-isomer], deltamethrin, empenthrin [(EZ)-(IR)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(IR)-trans-isomer], prallethrin, pyrethrins (pyrethrum), resmethrin, silafluofen, tefluthrin, tetramethrin, tetramethrin [(1R)-isomer)], tralomethrin, transfluthrin, DDT and methoxychlor;
(4) Nicotinic acetylcholine receptor (nAChR) competitive modulators which are neonicotinoids and preferably selected from acetamiprid, clothianidin, dinotefuran, imidacloprid, nitenpyram, thiacloprid and thiamethoxam, or nicotine, or sulfoximines and preferably selected from sulfoxaflor, or butenolids and preferably selected from flupyradifurone, or mesoionics and preferably selected from triflumezopyrim;
(5) Nicotinic acetylcholine receptor (nAChR) allosteric modulators which are spinosyns and preferably selected from spinetoram and spinosad;
(6) Glutamate-gated chloride channel (GIuCI) allosteric modulators which are avermectins/milbemycins and preferably selected from abamectin, emamectin benzoate, lepimectin and milbemectin;
(7) Juvenile hormone mimics which are juvenile hormone analogues and preferably selected from hydroprene, kinoprene, methoprene, fenoxycarb and pyriproxyfen;
(8) Miscellaneous non-specific (multi-site) inhibitors which are alkyl halides and preferably selected from methyl bromide and other alkyl halides, or chloropicrine or sulphuryl fluoride or borax or tartar emetic or methyl isocyanate generators selected from diazomet and metam;
(9) Chordotonal organ TRPV channel modulators selected from pymetrozine and pyrifluquinazone;
(10) Mite growth inhibitors selected from clofentezine, hexythiazox, diflovidazin and etoxazole;
(11) Microbial disruptors of the insect gut membrane selected from Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and pesticidally active proteins, e.g., originating from Bacillus thuringiensis;
(12) Inhibitors of mitochondrial ATP synthase which are ATP disruptors, preferably selected from diafenthiuron, or organotin compounds selected from azocyclotin, cyhexatin and fenbutatin oxide, or propargite or tetradifon;
(13) Uncouplers of oxidative phosphorylation via disruption of the proton gradient selected from chlorfenapyr, DNOC and sulfluramid;
(14) Nicotinic acetylcholine receptor channel blockers selected from bensultap, cartap hydrochloride, thiocylam and thiosultap-sodium;
(15) Inhibitors of chitin biosynthesis, type 0 selected from bistrifluron, chlorfluazuron, diflubenzuron, flucycloxuron, flufenoxuron, hexaflumuron, lufenuron, novaluron, noviflumuron, teflubenzuron and triflumuron;
(16) Inhibitors of chitin biosynthesis, type 1 selected from buprofezin;
(17) Moulting disrupter (in particular for Diptera, i.e., dipterans) selected from cyromazine;
(18) Ecdysone receptor agonists selected from chromafenozide, halofenozide, methoxyfenozide and tebufenozide;
(19) Octopamine receptor agonists selected from amitraz;
(20) Mitochondrial complex III electron transport inhibitors selected from hydramethylnone, acequinocyl and fluacrypyrim;
(21) Mitochondrial complex I electron transport inhibitors which are METI acaricides, preferably selected from fenazaquin, fenpyroximate, pyrimidifen, pyridaben, tebufenpyrad and tolfenpyrad, or rotenone (Derris);
(22) Voltage-dependent sodium channel blockers selected from indoxacarb and metaflumizone;
(23) Inhibitors of acetyl CoA carboxylase which are tetronic and tetramic acid derivatives, preferably selected from spirodiclofen, spiromesifen and spirotetramat;
(24) Mitochondrial complex IV electron transport inhibitors which are phosphines, preferably selected from aluminium phosphide, calcium phosphide, phosphine and zinc phosphide, or cyanides selected from calcium cyanide, potassium cyanide and sodium cyanide;
(25) Mitochondrial complex II electron transport inhibitors which are beta-ketonitrile derivatives, preferably selected from cyenopyrafen and cyflumetofen, and carboxanilides selected from pyflubumide;
(26) Ryanodine receptor modulators which are diamides, preferably selected from chlorantraniliprole, cyantraniliprole and flubendiamide;
(27) Chordotonal organ Modulators (with undefined target site) selected from flonicamid;
(28) further active compounds selected from acynonapyr, afidopyropen, afoxolaner, azadirachtin, benclothiaz, benzoximate, benzpyrimoxan, bifenazate, broflanilide, bromopropylate, chinomethionat, chloroprallethrin, cryolite, cyclaniliprole, cyclobutrifluram, cycloxaprid, cyhalodiamide, cyproflanilide, dicloromezotiaz, dicofol, dimpropyridaz, epsilon-metofluthrin, epsilon-momfluthrin, flometoquin, fluazaindolizine, fluensulfone, flufenerim, flufenoxystrobin, flufiprole, fluhexafon, flupentiofenox, fluopyram, flupyrimin, fluralaner, fluxametamide, fufenozide, guadipyr, heptafluthrin, imidaclothiz, iprodione, isocycloseram, kappa-bifenthrin, kappa-tefluthrin, lotilaner, meperfluthrin, oxazosulfyl, paichongding, pyridalyl, pyrifluquinazon, pyriminostrobin, spirobudiclofen, spiropidion, sulfur, tetramethylfluthrin, tetraniliprole, tetrachlorantraniliprole, tigolaner, tioxazafen, thiofluoximate, iodomethane; 1-{2-fluoro-4-methyl-5-[(2,2,2-trifluoroethyl)sulphinyl]phenyl}-3-(trifluoromethyl)-1H-1,2,4-triazole-5-amine, {1′-[(2E)-3-(4-chlorophenyl)prop-2-en-1-yl]-5-fluorospiro [indol-3,4′-piperidin]-1(2H)-yl}(2-chloropyridin-4-yl)methanone, 2-chloro-N-[2-{1-[(2E)-3-(4-chlorophenyl)prop-2-en-1-yl]piperidin-4-yl}-4-(trifluoromethyl)phenyl]isonicotinamide, 3-(4-chloro-2,6-dimethylphenyl)-4-hydroxy-8-methoxy-1,8-diazaspiro[4.5]dec-3-en-2-one, 3-(4-chloro-2,6-dimethylphenyl)-8-methoxy-2-oxo-1,8-diazaspiro[4.5]dec-3-en-4-yl ethyl carbonate, 4-(but-2-yn-1-yloxy)-6-(3,5-dimethylpiperidin-1-yl)-5-fluoropyrimidine, PF1364 (known from JP2010/018586), (3E)-3-[l-[(6-chloro-3-pyridyl)methyl]-2-pyridylidene]-1,1,1-trifluoro-propan-2-one, N-[3-(benzylcarbamoyl)-4-chlorophenyl]-1-methyl-3-(pentafluoroethyl)-4-(trifluoromethyl)-lH-pyrazole-5-carboxamide, 5-bromo-4-chloro-N-[4-chloro-2-methyl-6-(methylcarbamoyl)phenyl]-2-(3-chloro-2-pyridyl)pyrazole-3-carboxamide, 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide, N-[3-chloro-1-(3-pyridinyl)-1H-pyrazol-4-yl]-N-ethyl-3-[(3,3,3-trifluoropropyl)sulfinyll]-propanamide, (+)-N-[3-chloro-I-(3-pyridinyl)-1H-pyrazol-4-yl]-N-ethyl-3-[(3,3,3-trifluoropropyl)sulfinyl]-propanamide and (−)-N-[3-chloro-I-(3-pyridinyl)-1H-pyrazol-4-yl]-N-ethyl-3-[(3,3,3-trifluoropropyl)sulfinyl]-propanamide, 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile, 3-bromo-N-[4-chloro-2-methyl-6-[(methylamino)thioxomethyl]phenyl]-1-(3-chloro-2-pyridinyl)-1H-pyrazole-5-carboxamide; N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide, N-[2-(5-amino-1,3,4-thiadiazol-2-yl)-4-chloro-6-methylphenyl]-3-bromo-1-(3-chloro-2-pyridinyl)-1H-pyrazole-5-carboxamide, 4-[3-[2,6-dichloro-4-[(3,3-dichloro-2-propen-1-yl)oxy]phenoxy]propoxy]-2-methoxy-6-(trifluoromethyl)-pyrimidine; (2E)- and 2(Z)-2-[2-(4-cyanophenyl)-1-[3-(trifluoromethyl)phenyl]ethylidene]-N-[4-(difluoromethoxy)phenyl]-hydrazinecarboxamide; 3-(2,2-dichloroethenyl)-2,2-dimethyl-4-(1H-benzimidazol-2-yl)phenyl-cyclopropanecarboxylic acid ester; (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester; 6-deoxy-3-O-ethyl-2,4-di-O-methyl-1-[N-[4-[1-[4-(1,1,2,2,2-pentafluoroethoxy)phenyl]-1H-1,2,4-triazol-3-yl]phenyl]carbamate]-α-L-mannopyranose; 8-(2-cyclopropylmethoxy-4-trifluoromethyl-phenoxy)-3-(6-trifluoromethyl-pyridazin-3-yl)-3-aza-bicyclo[3.2. I]octane, (8-anti)-8-(2-cyclopropylmethoxy-4-trifluoromethyl-phenoxy)-3-(6-trifluoromethyl-pyridazin-3-yl)-3-aza-bicyclo [3.2.1]octane, (8-syn)-8-(2-cyclopropylmethoxy-4-trifluoromethyl-phenoxy)-3-(6-trifluoromethyl-pyridazin-3-yl)-3-aza-bicyclo [3.2.1]octane, N-[3-chloro-1-(3-pyridinyl)-1H-pyrazol-4-yl]-N-ethyl-3-[(3,3,3-trifluoropropyl)thio]-propanamide and N-[4-(aminothioxomethyl)-2-methyl-6-[(methylamino)carbonyl]phenyl]-3-bromo-I-(3-chloro-2-pyridinyl)-1H-pyrazole-5-carboxamide, 5-(1,3-dioxan-2-yl)-4-[[4-(trifluoromethyl)phenyl]methoxy]-pyrimidine, 3-(4-chloro-2,6-dimethylphenyl)-8-methoxy-1-methyl-1,8-diazaspiro[4.5]decane-2,4-dione, 3-(4-chloro-2,6-dimethylphenyl)-8-methoxy-1-methyl-2-oxo-1,8-diazaspiro[4.5]dec-3-en-4-yl-carbonic acid ethyl ester, and 4-[(5S)-5-(3,5-Dichloro-4-fluorophenyl)-4,5-dihydro-5-(trifluoromethyl)-3-isoxazolyl]-N-[(4R)-2-ethyl-3-oxo-4-isoxazobdinyl]-2-methyl-benzamide, 2-({2-fluoro-4-methyl-5-[(R)-(2,2,2-trifluoroethyl)sulfinyl]phenyl}imino)-3-(2,2,2-trifluoroethyl)-1,3-thiazolodin-4-one,1,4-dimethy-2-[2-(pyridin-3-yl)-2H-indazol-5-yl]-1,2,4-triazolidine-3,5-dione and a terpene blend comprising as active ingredients substantially pure α-terpinene, substantially pure p-cymene and substantially pure limonene in a relative ratio of about 35-45:12-20:10-15.

In one embodiment, the compositions comprise (A) pelargonic acid and (B) one or more of the following pesticidally active agents: abamectin, acephate, acetamiprid, acrinathrin, afidopyropen, aldicarb, amitraz, azocyclotin, bifenazate, bifenthrin, broflanilide, buprofezin, cadusafos, carbaryl, carbofuran, carbosulfan, chlorantraniliprole, chlorfenapyr, chlorpyrifos, chlorpyrifos-methyl, clofentezine, clothianidin, cyantraniliprole, cyfluthrin, beta-cyfluthrin, lambda-cyhalothrin, cyhexatin, cypermethrin, alpha-cypermethrin, cyromazine, deltamethrin, dicofol, diflubenzuron, dimethoate, dimpropyridaz, disulfoton, emamectin benzoate, esfenvalerate, ethiprole, ethoprophos, etofenprox, etoxazole, fenamiphos, fenazaquin, fenbutatin oxide, fenitrothion, fenoxycarb, fenpropathrin, fenpyroximate, fenvalerate, fipronil, flonicamid, fluazaindolizine, flubendiamide, flufenoxuron, tau-fluvalinate, fosthiazate, hexythiazox, imidacloprid, indoxacarb, lufenuron, malathion, metaflumizone, metam, methamidophos, methiocarb, methoxyfenozide, novaluron, oxamyl, parathion-methyl, permethrin, phorate, pirimicarb, profenofos, propargite, pymetrozine, pyridaben, spinetoram, spinosad, spirodiclofen, spiromesifen, spiropidion, spirotetramat, sulfoxaflor, tebufenozide, tebufenpyrad, tefluthrin, terbufos, tetraniliprole, thiacloprid, thiamethoxam, tioxazafen.

In one embodiment, the pesticidally active agent (B) is a biological control agent.

As used herein, “biological control” is defined as control of an insect and/or an acarid and/or a nematode by the use of an organism such as a microorganism or metabolite produced by such microorganism. In some cases, biological control is also achieved by the use of naturally occurring compounds or compounds derived from such naturally occurring compounds.

According to one embodiment of the present invention, the biological control agent comprises not only the isolated, pure cultures of the respective fungus or bacterium, in particular the pesticidally active fungus or bacterium but also suspensions in a whole broth culture or a metabolite-containing supernatant or a purified metabolite obtained from whole broth culture of the fungal or bacterial strain. “Whole broth culture” refers to a liquid culture containing both cells and media. “Supernatant” refers to the liquid broth remaining when cells grown in broth are removed by centrifugation, filtration, sedimentation, or other means well known in the art. According to another embodiment, the biological control agent comprises the isolated, pure cultures of the respective fungus or bacterium formulated in a suitable formulation apart from its fermentation broth, as described further below.

Said biological control agent may be an insecticidally active biological control agent selected from the group consisting of:
(1) bacteria selected from the group consisting of Bacillus thuringiensis subsp. aizawai, in particular strain ABTS-1857 (SD-1372; e.g. XENTARI® from Valent BioSciences); Bacillus mycoides, isolate J. (e.g. BmJ from Certis USA LLC, a subsidiary of Mitsui & Co.); Bacillus sphaericus, in particular Serotype H5a5b strain 2362 (strain ABTS-1743) (e.g. VECTOLEX® from Valent BioSciences, US); Bacillus thuringiensis subsp. kurstaki strain BMP 123 from Becker Microbial Products, IL; Bacillus thuringiensis subsp. aizawai, in particular serotype H-7 (e.g. FLORBAC® WG from Valent BioSciences, US); Bacillus thuringiensis subsp. kurstaki strain HD-1 (e.g. DIPEL® ES from Valent BioSciences, US); Bacillus thuringiensis subsp. kurstaki strain BMP 123 by Becker Microbial Products, IL; Bacillus thuringiensis israelensis strain BMP 144 (e.g. AQUABAC® by Becker Microbial Products IL); Burkholderia spp., in particular Burkholderia rinojensis strain A396 (also known as Burkholderia rinojensis strain MBI 305) (Accession No. NRRL B-50319; WO 2011/106491 and WO 2013/032693; e.g. MBI-206 TGAI and ZELTO® from Marrone Bio Innovations); Chromobacterium subtsugae, in particular strain PRAA4-1T (MBI-203; e.g. GRANDEVO® from Marrone Bio Innovations); Paenibacillus popilliae (formerly Bacillus popilliae; e g. MILKY SPORE POWDER™ and MILKY SPORE GRANULAR™ from St. Gabriel Laboratories); Bacillus thuringiensis subsp. israelensis (serotype EI-14) strain AM65-52 (Accession No. ATCC 1276) (e.g. VECTOBAC® by Valent BioSciences, US); Bacillus thuringiensis var. kurstaki strain EVB-113-19 (e.g., BIOPROTEC® from AEF Global); Bacillus thuringiensis subsp. tenebrionis strain NB 176 (SD-5428; e.g. NOVODOR® FC from BioFa DE); Bacillus thuringiensis var. japonensis strain Buibui; Bacillus thuringiensis subsp. kurstaki strain ABTS 351; Bacillus thuringiensis subsp. kurstaki strain PB 54; Bacillus thuringiensis subsp. kurstaki strain SA 11; Bacillus thuringiensis subsp. kurstaki strain SA 12; Bacillus thuringiensis subsp. kurstaki strain EG 2348; Bacillus thuringiensis var. Colmeri (e.g. TIANBAOBTC by Changzhou Jianghai Chemical Factory); Bacillus thuringiensis subsp. aizawai strain GC-91; Serratia entomophila (e.g. INVADE® by Wrightson Seeds); Serratia marcescens, in particular strain SRM (Accession No. MTCC 8708); and Wolbachia pipientis ZAP strain (e.g., ZAP MALES® from MosquitoMate); and
(2) fungi selected from the group consisting of Muscodor albus, in particular strain QST 20799 (Accession No. NRRL 30547); Muscodor roseus in particular strain A3-5 (Accession No. NRRL 30548); Beauveria bassiana, in particular strain ATCC 74040 (e.g. Naturalis® from Intrachem Bio Italia); strain GHA (Accession No. ATCC74250; e.g. BotaniGuard Es and Mycotrol-0 from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL 131, IL116 (all referenced in laronski, 2007. Use of Entomopathogenic Fungi in Biological Pest Management, 2007: ISBN: 978-81-308-0192-6), strain Bv025 (see e.g., Garcia et al. 2006. Manejo Integrado de Plagas y Agroecologia (Costa Rica) No. 77); strain BaGPK; strain ICPE 279, strain CG 716 (e.g. BoveMax® from Novozymes); Hirsutella citriformis, Hirsutella thompsonii (e.g. Mycohit and ABTEC from Agro Bio-tech Research Centre, IN); Lecanici Ilium lecanii (formerly known as Verticillium lecanii), in particular conidia of strain KV01 (e.g. Mycotal® and Vertalec® from Koppert/Arysta), strain DAOM198499 or strain DAOM216596; Lecanicillium muscarium (formerly Verticillium lecanii), in particular strain VE 6/CABI(=IMI) 268317/CBS102071/ARSEF5128 (e.g. Mycotal from Koppert); Metarhizium anisopliae var acridum, e.g. ARSEF324 from GreenGuard by Becker Underwood, US or isolate IMI 330189 (ARSEF7486; e.g. Green Muscle by Biological Control Products); Metarhizium brunneum, e.g. strain Cb 15 (e.g. ATTRACAP® from BIOCARE); Metarhizium anisopliae, e.g. strain ESALQ 1037 (e.g. from Metarril® SP Organic), strain E-9 (e.g. from Metarril® SP Organic), strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; Metarhizium robertsii 23013-3 (NRRL 67075); Nomuraea rileyi; Paecilomyces fumosoroseus (new: Isariafumosorosea), in particular strains Apopka 97 (available as PreFeRal from Certis, USA), Fe9901 (available as NoFly from Natural industries, USA), ARSEF 3581, ARSEF 3302, ARSEF 2679 (ARS Collection of Entomopathogenic Fungal Cultures, Ithaca, USA), IfBOI (China Center for Type Culture Collection CCTCC M2012400), ESALQ1296, ESALQ1364, ESALQ1409 (ESALQ: University of Sao Paulo (Piracicaba, SP, Brazil)), CG1228 (EMBRAPA Genetic Resources and Biotechnology (Brasilia, DF, Brazil)), KCH J2 (Dymarska et ah, 2017; PLoS one 12(10)): e0184885), HIB-19, HIB-23, HIB-29, HIB-30 (Gandarilla-Pacheco et ak, 2018; Rev Argent Microbiol 50: 81-89), CHE-CNRCB 304, EH-511/3 (Flores-Villegas et ak, 2016; Parasites & Vectors 2016 9:176 doi: 10.1186/s13071-016-1453-I), CHE-CNRCB 303, CHE-CNRCB 305, CHE-CNRCB 307 (Gallou et ak, 2016; fungal biology 120 (2016) 414-423), EH-506/3, EH-503/3, EH-520/3, PFCAM, MBP, PSMB1 (National Center for Biololgical Control, Mexico; Castellanos-Moguel et ak, 2013; Revista Mexicana De Micologia 38: 23-33, 2013), RCEF3304 (Meng et ak, 2015; Genet Mol Biol. 2015 July-September; 38(3): 381-389), PF01-N10 (CCTCC No. M207088), CCM 8367 (Czech Collection of Microorganisms, Bmo), SFP-198 (Kim et ak, 2010; Wiley Online: DOI 10.1002/ps.2020), K3 (Y anagawa et ak, 2015; J Chem Ecok 2015; 41(12): 118-1126), CLO 55 (Ansari Ali et ak, 2011; PLoS One. 2011; 6(1): e16108. DOI: 10.1371/joumakpone.0016108), IfTSOI, HTSO2, HTS07 (Dong et ak 2016/PLoS ONE 11(5): e0156087. doi: 10.1371/joumakpone.0156087), PI (Sun Agro Biotech Research Centre, India), If-02, If-2.3, If-03 (Farooq and Freed, 2016; DOI: 10.1016/j.bjm.2016.06.002), Ifir AsC (Meyer et ak, 2008; J. Invertebr. Pathol. 99:96-102. 10.1016/j jip.2008.03.007), PC-013 (DSMZ 26931), P43A, PCC (Carrillo-Perez et ak, 2012; DOI 10.1007/sl 1274-012-1184-1), Pf04, Pf59, Pfl09 (KimJun et ak, 2013; Mycobiology 2013 December; 41(4): 221-224), FG340 (Han et ak, 2014; DOI: 10.5941/MYCO.2014.42.4.385), Pfirl, Pfr8, Pfr9, PfrlO, Pfirl 1, Pfrl2 (Angel-Sahaghn et ak, 2005; Journal of Insect Science), Ifr531 (Daniel and Wyss, 2009; DOI 10.1111/j.1439-0418.2009.01410.x), IF-1106 (Insect Ecology and Biocontrol Laboratory, Shanxi Agricultural University), 19602, 17284 (Hussain et ak 2016, DOI: 10.3390/ijms17091518), 103011 (U.S. Pat. No. 4,618,578), CNRCB1 (Centro Nacional de Referenda de Control Biologico (CNRCB), Colima, Mexico), SCAU-IFCF01 (Nian et ak, 2015; DOI: 10.1002/ps.3977), PF01-N4 (Engineering Research Center of Biological Control, SCAU, Guangzhou, P. R. China) Pfr-612 (Institute of Biotechnology (IB—FCB-UANL), Mexico), Pf-Tim, Pf-Tiz, Pf-Hal, Pf-Tic (Chan-Cupul et ak 2013, DOI: 10.5897/AJMR12.493); Aschersonia aleyrodis; Beauveria brongniartii (e.g. Beaupro from Andermatt Biocontrol AG); Conidiobolus obscurus; Entomophthora virulenta (e.g. Vektor from Ecomic); Lagenidium giganteum; Metarhizium flavoviride; Mucor haemelis (e.g. BioAvard from Indore Biotech Inputs & Research); Nosema locustae; Pandora delphacis; Sporothrix insectorum (e.g. Sporothrix Es from Biocerto, BR); and Zoophtora radicans, and
(3) viruses selected from the group consisting of Adoxophyes honmai nucleopolyhedrovirus (AdhoNPV), e.g. isolate ADN001; Agrotis ipsilon multiple nucleopolyhedrovirus (AgipNPV), e.g. isolate from Illinois; Anticarsia gemmatalis (Woolly pyrol moth) multiple nucleopolyhedrovirus (AgMNPV) (e.g. products Baculo-soja from Nova Era Biotecnologia Agricola; Baculovirus Nitral from Nitral Urbana; Coopervirus SC from COODETEC), e.g. isolate 2D; Autographa californica (Alfalfa Looper) multiple nucleopolyhedrovirus (AcMNPV) (e.g. product VPN-ULTRA from Agricola El Sol, Loopex from Andermatt Biocontrol, Lepigen from AgBiTech), e.g. isolate C6; Galleria mellonella multiple nucleopolyhedrovirus (GmMNPV); Plutella xylostella multiple nucleopolyhedrovirus, e.g. isolate CL3; Spodoptera exempta multiple nucleopolyhedrovirus (SpexNPV); Trichoplusia ni multiple nucleopolyhedrovirus (TnMNPV); Bombyx mori (silkworm) nucleopolyhedrovirus (BmNPV), e.g. isolate T3; (C3.10) Bombyx mandarina nucleopolyhedrovirus (BomaNPV), e.g. isolate SI; Buzura suppressaria nucleopolyhedrovirus (BuzuNPV), e.g. isolate S13; Choristoneurafumiferana DEF multiple nucleopolyhedrovirus (CfDefNPV); Choristoneura fumiferana multiple nucleopolyhedrovirus (CfMNPV), e.g. isolate from Ireland; Choristoneura rosaceana nucleopolyhedrovirus (ChroNPV); Ecotropis obliqua nucleopolyhedrovirus (EcobNPV), e.g. isolate A1; Epiphyas postvittana nucleopolyhedrovirus (EppoNPV); Heliocoverpa armigera (cotton bollworm) nucleopolyhedrovirus (Hear-NPV) (e.g. Vivus® MAX and Armigen from AgBiTech, Helicovex from Andermatt Biocontrol, Keyun HaNPV), such as isolate Cl (HearNPV-CI), isolate NNG1 (HearNPV-NNG1), isolate G4 (HearNPV-G4; Helicoverpa zea single nucleopolyhedrovirus (HzSNPV) (e.g. Gemstar from Certis USA, Diplomata from Koppert); Lymantria dispar (gypsy moth) multiple nucleopolyhedrovirus (LdMNPV) (e.g. Lymantria dispar from Andermatt Biocontrol, Gypcheck developed by the US Forestry Service); Mamestra brassicae multiple nucleopolyhedrovirus (MbMNPV), e.g. isolate from Oxford; Mamestra configurata nucleopolyhedrovirus A (MacoNPV-A), e.g. isolate 90/2 or isolate 90/4; Mamestra configurata nucleopolyhedrovirus B (MacoNPV-B), e.g. isolate 96B; Orgyia pseudotsugata (Douglas-fir tussock moth) multiple nucleopolyhedrovirus (OpMNPV) (e.g. Virtuss); Spodoptera exigua (beet armyworm) multiple nucleopolyhedrovirus (SeMNPV) (e.g. Spexit from Andermatt Biocontrol, Spod-X LC from Certis USA, Keyun SeNPV), e.g. isolate from the US; Spodoptera frugiperda (fall armyworm) multiple nucleopolyhedrovirus (SfMNPV) (e.g. Fawligen from AgBiTech), e.g. isolate 3AP2 or isolate 6NR; Spodoptera littoralis (African cotton leafworm) nucleopolyhedrovirus (SpliNPV) (e.g. Littovir from Andermatt Biocontrol), e.g. isolate M2; Spodoptera litura (oriental leafworm moth) nucleopolyhedrovirus (SpItNPV) (e.g. Keyun SpItNPV), e.g. isolate G2; Thysanoplusia orichalcea nucleopolyhedrovirus (ThorNPV), e.g. isolate A28; Trichoplusia ni single nucleopolyhedrovirus (TnSNPV); (C3.30) Wiseana signata nucleopolyhedrovirus (WisiNPV); Adoxophyes orana (summer fruit tortrix) granulovirus (AdorGV) (e.g.

Capex from Andermatt Biocontrol); Agrotis segetum nucleopolyhedrovirus A (AgseNPV); Anagrapha falcifera multiple nucleopolyhedrovirus (AnfaNPV); Antheraea pemyi nucleopolyhedrovirus (AnpeNPV); Chrysodeixis chalcites nucleopolyhedrovirus (ChchNPV); Clanis bilineata nucleopolyhedrovirus (ClbiNPV); Euproctis pseudoconspersa nucleopolyhedrovirus (EupsNPV); Hyphantria cunea nucleopolyhedrovirus (HycuNPV); Leucania separata nucleopolyhedrovirus (LeseNPV); Maruca vitrata nucleopolyhedrovirus (MaviNPV); Orgyia leucostigma nucleopolyhedrovirus (OrIeNPV); Orgyia pseudotsugata single nucleopolyhedrovirus (OpSNPV); Panolis flammea nucleopolyhedrovirus (PafINPV); Rachiplusia ou multiple nucleopolyhedrovirus (RoMNPV); Erinnyis ello (homworm) GV (ErelGV), e.g. isolate VG010; Artogeia rapae granulovirus (ArGV); Pieris brassicae granulovirus (PbGV), e.g. isolate 384; Choristoneura fumiferana granulovirus (ChfuGV), e.g. isolate Bonaventure; Cryptophlebia leucotreta (false codling moth) granulovirus (CrIeGV) (e.g. Cryptex from Andermatt Biocontrol), e.g. isolate CV3; Cydia pomonella (codling moth) granulovirus (CpGV) (e.g. Madex® products from Andermatt Biocontrol, Carpovirus Plus from AgroRoca SA), e.g. isolate M1; Harrisina brillians granulovirus (HabrGV), e.g. isolate M2; Helicoverpa armigera (cotton bollworm) granulovirus (HearGV); Lacanobia oleracea granulovirus (LaolGV), e.g. isolate SI; Phthorimaea operculella (tobacco leaf miner) granulovirus (PhopGV) (e.g. Tutavir from Andermatt Biocontrol, Matapol); Plodia interpunctella granulovirus (PiGV), e.g. isolate B3; Plutella xylostella granulovirus (PlxyGV) (e.g. Plutellavex® from Keyun), e.g. isolate KI; Pseudalatia unipuncta granulovirus (PsunGV), e.g. Hawaiian isolate; Trichoplusia ni granulovirus (TnGV), e.g. isolate M10-5: Xestia c-nigrum granulovirus (XecnGV), e.g. isolate alpha4; Agrotis segetum granulovirus (AgseGV), e.g. isolate Xinjiang; Choristoneura occidentalis granulovirus (ChocGV); Spodoptera litura (oriental leafworm moth) granulovirus (SpliGV), e.g. isolate KI; Neodiprion lecontei (red-headed pinesawfly) nucleopolyhedrovirus (NeleNPV) (e.g. Lecontvirus from SYLVAR); Neodiprion sertifer (Pine sawfly) nucleopolyhedrovirus (NeseNPV) (e.g. Neocheck-S developed by the US Forestry Service; Gilpinia hercyniae nucleopolyhedrovirus (GiheNPV), e.g. isolate i7; Neodiprion abietis (balsam-fir sawfly) nucleopolyhedrovirus (NeabNPV) (e.g. ABIETIV from SYLVAR); Culex nigripalpus nucleopolyhedrovirus (CuniNPV), e.g. isolate from Florida (1997); Aedes sollicitans nucleopolyhedrovirus (AesoNPV); Uranotaenia sapphrinia nucleopolyhedrovirus (UrsaNPV); Spodoptera albula (gray-streaked armywom moth) NPV (e.g. VPN-ULTRA from Agricola El Sol); Biston suppressaria (tea looper) NPV; Dendrolimus punctatus (Masson pine moth) CPV; Leucomasalicis (satin moth) NPV; Spodoptera frugiperda granulovirus (SfGV), e.g. isolate ARG; Spodoptera sunia nulear polyhedrosisvirus (e.g. VPN 82 from Agricola El Sol); Pieris rapae (small white) GV (PiraGV); Spodoptera exigua (beet armyworm) nucleopolyhedrovirus (SeNPV) (e.g. Keyun SeNPV) and Zucchini yellow mosaic virus.

Said biological control agent may be a nematicidally active biological control agent selected from the group consisting of
(4) bacteria, for example Bacillus subtilis, in particular strain QST713/AQ713 (having NRRL Accession No. B-21661; available as SERENADE® OPTI or SERENADE® ASO from Bayer CropScience LP, US); Bacillus pumilus, in particular strain QST2808 (having Accession No. NRRL No. B-30087); Bacillus firmus, in particular, strain CNMC 1-1582 (e.g. VOTIVO® from BASF SE); Bacillus amyloliquefaciens, in particular strain FZB42 (e.g. RHIZOVITAL® from ABiTEP, DE); Bacillus amyloliquefaciens strain PTA-4838 (AVEO EZ® from Valent/Sumitomo; VARNIMO® ST from LidoChem); Bacillus cereus, in particular spores of Bacillus cereus strain CNCM 1-1562 (cf. U.S. Pat. No. 6,406,690); Bacillus laterosporus (also known as Brevibacillus laterosporus; e.g. BIO-TODE® from Agro-Organics, ZA); Bacillus megaterium, strain YFM3.25 (e.g. BIOARC® from BioArc); Bacillus mojavensis, strain SR11 (CECT-7666; by Probelte S.A); Bacillus nematocida B16 (CGMCC Accession No. 1128); a mixture of Bacillus licheniformis FMCHOOI and Bacillus subtilis FMCH002 (available as QUARTZO® (WG), PRESENCE® (WP) from FMC Corporation); Pasteuria nishizawae (e.g. OYACYST® LF/ST from Pasteuria Bioscience; CLARIVA® PN from Syngenta/ChemChina); Burkholderia rinojensis strain A396 (also known as Burkholderia rinojensis strain MBI 305) (Accession No. NRRL B-50319; WO 2011/106491 and WO 2013/032693; MAJESTENE® from Marrone Bio Innovations); Pasteuria penetrans; Pasteuria usgae (e.g. ECONEM™ from Pasteuria Bioscience); Streptomycetes sp., such as Streptomyces lydicus strain WYEC108 (also known as Streptomyces lydicus strain WY CD 108US) (ACTINO-IRON® and ACTINOVATE® from Novozymes); Streptomyces saraceticus (e.g. CLANDA® from A & A Group (Agro Chemical Corp.); Bacillus thuringiensis strain CR-371 (Accession No. ATCC 55273); Bacillus cepacia (e.g. DENY® from Stine Microbial Products); Lysobacterenzymogenes, in particular strain C3 (cf. J Nematol. 2006 June, 38(2): 233-239 and Biological Control 2018 February, 117: 158-163); and fungi, for example Muscodor albus, in particular strain QST 20799 (Accession No. NRRL 30547); Muscodor roseus, in particular strain A3-5 (Accession No. NRRL 30548); Purpureocillium lilacinum (previously known as Paecilomyces lilacinus), in particular P. lilacinum strain 251 (AGAL 89/030550; e.g. BioAct from Bayer CropScience Biologies GmbH), strain 580 (BIOSTAT® WP (ATCC No. 38740) by Laverlam), strain in the product BIO-NEMATON® (T. Stanes and Company Ltd.), strain in the product MYSIS® (Varsha Bioscience and Technology India Pvt Ltd.), strain in the product BIOICONEMA® (Nico Orgo Maures, India), strain in the product NEMAT® (Ballagro Agro Tecnologia Ltda, Brazil), and a strain in the product SPECTRUM PAE L® (Promotora Tecnica Industrial, S.A. DE C.V., Mexico); Trichoderma koningii; Harposporium anguillullae; Hirsutella minnesotensis; Monacrosporium cionopagum; Monacrosporium psychrophilum; Myrothecium verrucaria, in particular strain AARC-0255 (e.g. DiTera™ by Valent Biosciences); Paecilomyces variotii, strain Q-09 (e.g. Nemaquim® from Quimia, MX); Stagonospora phaseoli (e.g. from Syngenta); Trichoderma lignorum, in particular strain TL-0601 (e.g. Mycotric from Futureco Bioscience, ES); Fusarium solani, strain Fs5; Hirsutella rhossiliensis; Monacrosporium drechsleri; Monacrosporium gephyropagum; Nematoctonus geogenius; Nematoctonus leiosporus; Neocosmospora vasinfecta; Paraglomus sp, in particular Paraglomus brasilianum; Pochonia chlamydosporia (also known as Vercillium chlamydosporium), in particular var. catenulata (IMI SD 187; e.Fg. KlamiC from The National Center of Animal and Plant Health (CENSA), CU); Stagonospora heteroderae; Meristacrum asterospermum, and Duddingtonia flagrans.

Preferred biological control agents are Bacillus thuringiensis; Chromobacterium subtsugae, Bacillus popilliae; Beauveria bassiana; Lecanicillium muscarium; Metarhizium anisopliae; Isaria fumosorosea; Lagenidium giganteum; Nosema locustae; Helicoverpa zea single nucleopolyhedrovirus; Lymantria dispar (gypsy moth) multiple nucleopolyhedrovirus; Spodoptera frugiperda (fall armyworm) multiple nucleopolyhedrovirus; Adoxophyes orana (summer fruit tortrix) granulovirus; Cydia pomonella (codling moth) granulovirus; Helicoverpa armigera (cotton bollworm) granulovirus; Plodia interpunctella granulovirus; Spodoptera exigua (beet armyworm) nucleopolyhedrovirus; Zucchini yellow mosaic virus; Bacillus firmus; Pasteuria nishizawae; Pasteuria usgae; Purpureocillium lilacinum and Myrothecium verrucaria.

The mixtures as described above can be used in a method for controlling pests, which comprises applying a composition comprising a mixture as described above to the pests or their environment, with the exception of a method for treatment of the human or animal body by surgery or therapy and diagnostic methods practiced on the human or animal body.

The combinations comprising mixtures of pelargonic acid and one or more active agents as described above can be applied, for example, in a single “ready-mix” form, in a combined spray mixture composed from separate formulations of the single active agent components, such as a “tank-mix”, and in a combined use of (A) a pelargonic acid and (B) a separate composition comprising the additional active agent when applied in a sequential manner, i.e., one after the other with a reasonably short period, such as a few hours or days. The order of applying the pelargonic acid and the active agents as described above is not essential for working the present invention.

A preferred method of application in the field of crop protection is application to the foliage of the plants (foliar application), it being possible to select frequency and rate of application to match the danger of infestation with the pest in question.

The following examples illustrate the invention in a non-limiting fashion.

All applications below were made with an EC formulation containing 650 g/L of pelargonic acid (e.g., 685 g/L of 95% purity pelargonic acid), an anionic emulsifier and a branched fatty acid ester solvent. The treatment names for the pelargonic acid compositions used in the following examples indicate the total g/ha based on the application rate e.g., the 650 EC formulation applied at 1 L/ha is identified as PA 650 g/ha; an application rate of 1.5 L/ha is identified as PA 975 g/ha.

Abbreviations used in the following examples include:
COU INS=Count of insects
% UNCK=percent of untreated check, i.e., % efficacy

### Example 1

Tomato—Spodoptera exigua (Beet Armyworm)

Trial conducted in 4 replicates on plots of 10 plants each. Application A was made at the occurrence of the insects.

The statistical design of this study was a completely randomized blocks design including 4 replicates. The homogeneity of variance was tested for all treatments and assessment dates by means of the Bartlett's test. In order to study the effect of the applied treatments for each assessment data, means were compared using Student-Newman-Keuls (p=0.05).

| Pest | | | | Spodoptera | Spodoptera | Spodoptera |
|---|---|---|---|---|---|---|
| | | | | exigua | exigua | exigua |
| Crop | | | | Tomato | Tomato | Tomato |
| Description | | | | Damage | Nr | Nr of |
| | | | | severity | damaged | larvae |
| | | | | | leaves | |
| Part rated | | | | Plant | Leaf | Larva |
| Rating unit | | | | (1-4) % | (number) % | (number) % |
| | | | | UNCK | UNCK | UNCK |
| Sample size | | | | 10 | 10 | 10 |
| | | | | plants | plants | plants |
| Water volume | | | | 800 | 800 | 800 |
| | | | | L/ha | L/ha | L/ha |
| Treatment-Evaluation interval | | | | 15 DAA | 15 DAA | 15 DAA |
| Treatment | Rate | Rate | Application | | | |
| name | | unit | code | | | |
| UTC | | | | 1.43 | 5.03 | 1.89 |
| | | | | (1-4) b | (number) b | (number) c |
| PA 650 g/ha | 1 | L/ha | A | 61.37 a | 63.30 a | 73.85 b |
| PA 1300 g/ha | 2 | L/ha | A | 61.01 a | 71.72 a | 79.47 b |
| PA 2600 g/ha | 4 | L/ha | A | 64.85 a | 63.54 a | 90.18 a |
| Karate Zeon | 0.13 | % w/v | A | 63.02 a | 64.12 a | 93.69 a |

Karate Zeon = lambda-cyhalothrin 100 g/L CS formulation (capsule suspension)

Phytotoxicity - General Injury (PHYGEN)

| | | | | Tomato | Tomato | Tomato | Tomato |
|---|---|---|---|---|---|---|---|
| Trt-eval interval | | | | 0 DAA | 2 DAA | 8 DAA | 15 DAA |
| Description | | | | PHYGEN | PHYGEN | PHYGEN | PHYGEN |
| | | | | % | % | % | % |
| Treatment | Rate | Rate | Application | | | | |
| name | | unit | code | | | | |
| UTC | | | | 0 | 0 | 0 | 0 |
| PA 650 g/ha | 1 | L/ha | A | 0 | 0 | 0 | 0 |
| PA 1300 g/ha | 2 | L/ha | A | 0 | 0 | 0 | 0 |
| PA 2600 g/ha | 4 | L/ha | A | 0 | 0 | 0 | 0 |
| Karate Zeon | 0.13 | % w/v | A | 0 | 0 | 0 | 0 |

### Example 2

Tomato—Tuta absoluta (Tomato Leafminer)

Trial conducted in 4 replicates on plots of 25 plants each. Application was made at the occurrence of the insects.

Application A was made to the crop at Stage BBCH 63; Application B was made 14 days after Application A at Stage BBCH 72.

Insects present at the time of application: at App A 0.3/plot, at App B in untreated: 34/plot

Efficacy is assessed by checking on the leaves the % of damage caused by the insects.

| Pest | | | | Tuta | Tuta | Tuta | Tuta | Tuta |
|---|---|---|---|---|---|---|---|---|
| | | | | absoluta | absoluta | absoluta | absoluta | absoluta |
| Crop | | | | Tomato | Tomato | Tomato | Tomato | Tomato |
| Description | | | | # | # | # | # | # |
| | | | | Damaged | Damaged | Damaged | Damaged | Damaged |
| | | | | leaves | leaves | leaves | leaves | leaves |
| Part rated | | | | Leaf | Leaf | Leaf | Leaf | Leaf |
| Rating unit | | | | % UNCK | % UNCK | % UNCK | % UNCK | % UNCK |
| Sample size | | | | 50 leaves | 50 leaves | 50 leaves | 50 leaves | 50 leaves |
| Trt-Eval interval | | | | 3 DAA | 7 DAA | 14 DAA | 3 DAB | 7 DAB |
| Treatment | Rate | Rate | Application | | | | | |
| name | | unit | code | | | | | |
| UTC | | | | 5.85 | 10.05 | 12.48 | 31.3 | 33.3 |
| (damage %) | | | | | | | | |
| PA 1300 | 2 | L/ha | AB | 47 | 68 | 70 | 31 | 32 |
| g/ha | | | | | | | | |
| PA 1950 | 3 | L/ha | AB | 51 | 69 | 72 | 42 | 46 |
| g/ha | | | | | | | | |
| PA 2600 | 4 | L/ha | AB | 58 | 74 | 78 | 47 | 42 |
| g/ha | | | | | | | | |
| PA 5200 | 8 | L/ha | AB | 59 | 75 | 75 | 42 | 49 |
| g/ha | | | | | | | | |
| Steward | 0.125 | kg/ha | AB | 56 | 71 | 69 | 35 | 46 |

Steward = indoxacarb 30% WG

Phytotoxicity - Necrosis/burn (PHYNEC)

| Crop | | | | Tomato | Tomato | Tomato | Tomato |
|---|---|---|---|---|---|---|---|
| Description | | | | PHYNEC | PHYNEC | PHYNEC | PHYNEC |
| Trt-Eval interval | | | | 3 DAA | 7 DAA | 14 DAA | 7 DAB |
| Treatment | Rate | Rate | Application | | | | |
| name | | unit | code | | | | |
| UTC | | | | 0 | 0 | 0 | 0 |
| PA 1300 g/ha | 2 | L/ha | AB | 0 | 0 | 0 | 0 |
| PA 1950 g/ha | 3 | L/ha | AB | 0 | 0 | 0 | 0 |
| PA 2600 g/ha | 4 | L/ha | AB | 0 | 0 | 0 | 0 |
| PA 5200 g/ha | 8 | L/ha | AB | 0 | 0 | 0 | 0 |
| Steward | 0.125 | kg/ha | AB | 0 | 0 | 0 | 0 |

### Example 3

Comparison of the levels of phytotoxicity of pelargonic acid to a commercially important insecticide (Chlorantraniliprole) for tomato.

Application A was made to the crop at Stage BBCH 63-64; Application B was made 14 days later.

Phytotoxicity - Necrosis/burn (PHYNEC)

| Crop | | | | Tomato | Tomato | Tomato | Tomato | Tomato |
|---|---|---|---|---|---|---|---|---|
| Description | | | | PHYNEC | PHYNEC | PHYNEC | PHYNEC | PHYNEC |
| Trt-Eval interval | | | | 3 DAA | 7 DAA | 14 DAA | 7 DAB | 14 DAB |
| Treatment | Rate | Rate | Application | | | | | |
| name | | unit | code | | | | | |
| UTC | | | | 0 | 0 | 0 | 0 | 0 |
| PA 1300 g/ha | 2 | L/ha | AB | 0 | 0 | 0 | 0 | 0 |
| PA 1950 g/ha | 3 | L/ha | AB | 0 | 1 | 1 | 1 | 1 |
| PA 2600 g/ha | 4 | L/ha | AB | 0 | 6 | 5 | 6 | 5 |
| PA 5200 g/ha | 8 | L/ha | AB | 0 | 15 | 13 | 18 | 15 |
| Altacor | 0.12 | kg/ha | AB | 0 | 0 | 0 | 0 | 0 |

Altacor = Chlorantraniliprole 35% WG

### Example 4

Comparison of the levels of phytotoxicity of pelargonic acid to a commercially important insecticide (Spinosad) for tomato.

Application A was made to the crop at Stage BBCH 63-71; Application B was made 14 days after Application A at Stage BBCH 65-71.

Phytotoxicity - Leaf curl (PHYLCU)

| Crop | | | | Tomato | Tomato | Tomato | Tomato | Tomato |
|---|---|---|---|---|---|---|---|---|
| Description | | | | PHYLCU | PHYLCU | PHYLCU | PHYLCU | PHYLCU |
| Trt-Eval interval | | | | 3 DAA | 7 DAA | 14 DAA | 7 DAB | 14 DAB |
| Treatment | Rate | Rate | Application | | | | | |
| name | | unit | code | | | | | |
| UTC | | | | 0 | 0 | 0 | 0 | 0 |
| PA 1300 g/ha | 2 | L/ha | AB | 0 | 0 | 0 | 0 | 0 |
| PA 1950 g/ha | 3 | L/ha | AB | 0 | 0 | 0 | 0 | 0 |
| PA 2600 g/ha | 4 | L/ha | AB | 0 | 0 | 0 | 0 | 0 |
| PA 5200 g/ha | 8 | L/ha | AB | 0 | 0 | 0 | 0 | 0 |
| Laser 480 | 25 | ml/ha | AB | 0 | 0 | 0 | 0 | 0 |

Laser 480 = Spinosad 480 SC

### Example 5

Peas—Aphis fabae (Black bean aphid)

The trial was conducted on peas, variety Batuta, 4 replicates per plot. A water volume of 200 L water/ha was used for each application. Two applications were made, Application A was made at first infestation and Application B was made 14d later. Each plot at least 12 m².

Insects present at the time of application: at App A 197/20 shoots, at App B in untreated: 443/20 shoots.

| Pest | | | | Aphis | Aphis | Aphis | Aphis |
|---|---|---|---|---|---|---|---|
| | | | | fabae | fabae | fabae | fabae |
| Crop | | | | Pea | Pea | Pea | Pea |
| Description | | | | COUINS | COUINS | COUINS | COUINS |
| Part rated | | | | 20 shoots | 20 shoots | 20 shoots | 20 shoots |
| Rating unit | | | | % UNCK | % UNCK | % UNCK | % UNCK |
| Sample size | | | | #/20 | #/20 | #/20 | #/20 |
| | | | | shoots | shoots | shoots | shoots |
| Trt-Eval interval | | | | 3 DAA | 7 DAA | 3 DAB | 7 DAB |
| Treatment | Rate | Rate | Application | | | | |
| name | | unit | code | | | | |
| UTC (#aphids) | | | | 483 | 448 | 231 | 142 |
| PA 585 g/ha | 0.9 | L/ha | AB | 7.66 | 17.73 | 32.43 | 33.74 |
| PA 975 g/ha | 1.5 | L/ha | AB | 9.21 | 22.27 | 39.08 | 51.21 |
| PA 1300 g/ha | 2.0 | L/ha | AB | 44.25 | 63.58 | 65.79 | 65.14 |
| PA 2600 g/ha | 4.0 | L/ha | AB | 72.11 | 82.08 | 76.77 | 76.67 |
| Decis Mega 50 EW | 0.15 | L/ha | AB | 57.92 | 83.02 | 81 | 91.83 |

Decis Mega 50 EW = deltamethrin 50 g/L EW formulation

Phytotoxicity - Chlorosis (PHYCHL)

| Crop | | | | Pea | Pea | Pea | Pea |
|---|---|---|---|---|---|---|---|
| Description | | | | PHYCHL | PHYCHL | PHYCHL | PHYCHL |
| Trt-Eval interval | | | | Same | 3 DAA | 7 DAA | 14 DAA |
| | | | | day A | | | |
| Treatment | Rate | Rate | Application | | | | |
| name | | unit | code | | | | |
| UTC | | | | 0 | 0 | 0 | 0 |
| PA 585 g/ha | 0.9 | L/ha | AB | 0 | 0 | 0 | 0 |
| PA 975 g/ha | 1.5 | L/ha | AB | 0 | 2 | 2 | 2 |
| PA 1300 g/ha | 2.0 | L/ha | AB | 5 | 5 | 6 | 4 |
| PA 2600 g/ha | 4.0 | L/ha | AB | 15 | 15 | 20 | 20 |
| Decis Mega 50 EW | 0.15 | L/ha | AB | 0 | 0 | 0 | 0 |
| Crop | | | | Pea | Pea | Pea | Pea |
| Description | | | | PHYCHL | PHYCHL | PHYCHL | PHYCHL |
| Trt-Eval interval | | | | Same | 3 DAB | 7 DAB | 14 DAB |
| | | | | day B | | | |
| Treatment | Rate | Rate | Application | | | | |
| name | | unit | code | | | | |
| UTC | | | | 0 | 0 | 0 | 0 |
| PA 585 g/ha | 0.9 | L/ha | AB | 0 | 0 | 0 | 0 |
| PA 975 g/ha | 1.5 | L/ha | AB | 3 | 2 | 2 | 0 |
| PA 1300 g/ha | 2.0 | L/ha | AB | 4 | 6 | 6 | 0 |
| PA 2600 g/ha | 4.0 | L/ha | AB | 20 | 23 | 13 | 2 |
| Decis Mega 50 EW | 0.15 | L/ha | AB | 0 | 0 | 0 | 0 |

### Example 6

Peas—Acyrthosiphon pisum (Pea Aphid)

Trial conducted on peas, variety Navarro, 4 replicates per plot. Each plot was at least 12 m², a water volume of 200 L water per ha was used for the application.

Insects present at the time of application A: 106 aphids per 20 shoots. The stage of the crop at application A was BBCH 75-77, and at application B, (14 DAA) BBCH 79-81.

| Pest | | | | Acyrthosiphon | Acyrthosiphon | Acyrthosiphon |
|---|---|---|---|---|---|---|
| | | | | pisum | pisum | pisum |
| Crop | | | | Pea | Pea | Pea |
| Description | | | | COUINS | COUINS | COUINS |
| Part rated | | | | 20 shoots | 20 shoots | 20 shoots |
| Rating unit | | | | % UNCK | % UNCK | % UNCK |
| Sample size | | | | #/20 shoots | #/20 shoots | #/20 shoots |
| Trt-Eval interval | | | | 3 DAA | 3 DAA | 3 DAA |
| Treatment | Rate | Rate | Application | | | |
| name | | unit | code | | | |
| UTC | | | | 79.8 | 62.8 | 25.3 |
| PA 585 g/ha | 0.9 | L/ha | A | 31.44 | 31.34 | 30.01 |
| PA 975 g/ha | 1.5 | L/ha | A | 34.03 | 33.84 | 35.76 |
| PA 1300 g/ha | 2.0 | L/ha | A | 52.54 | 52.47 | 53.62 |
| PA 2600 g/ha | 4.0 | L/ha | A | 65.75 | 65.86 | 65.31 |
| Decis Mega 50 EW | 0.15 | L/ha | A | 78.22 | 78.16 | 81.46 |

Decis Mega 50 EW = deltamethrin 50 g/L EW formulation

Phytotoxicity - Necrosis/burn (PHYNEC)

| Crop | | | | Pea | Pea |
|---|---|---|---|---|---|
| Description | | | | PHYNEC | PHYNEC |
| Trt-Eval interval | | | | 7 DAA | 14 DAA |
| Treatment | Rate | Rate | Application | | |
| name | | unit | code | | |
| UTC | | | | 0 | 0 |
| PA 585 g/ha | 0.9 | L/ha | AB | 0 | 0 |
| PA 975 g/ha | 1.5 | L/ha | AB | 0 | 0 |
| PA 1300 g/ha | 2.0 | L/ha | AB | 3 | 3 |
| PA 2600 g/ha | 4.0 | L/ha | AB | 37.5 | 37.5 |
| Decis Mega 50 EW | 0.5 | L/ha | AB | 0 | 0 |

### Example 7

Additional trials were conducted comparing the levels of phytotoxicity of pelargonic acid to two commercially important Deltamethrin products for peas, Decis™ Mega 50 EW and Scatto™ insecticides.

Application A was made to the crop at Stage BBCH 61-63; Application B was made 14 days later.

| Crop | | | | Pea | Pea | Pea | Pea | Pea | Pea |
|---|---|---|---|---|---|---|---|---|---|
| Description | | | | PHYNEC | PHYNEC | PHYNEC | PHYNEC | PHYNEC | PHYNEC |
| Trt-Eval interval | | | | 3 DAA | 7 DAA | 14 DAA | 3 DAB | 7 DAB | 14 DAB |
| Treatment | Rate | Rate | Application | | | | | | |
| name | | unit | code | | | | | | |
| UTC | | | | 0 | 0 | 0 | 0 | 0 | 0 |
| PA 585 g/ha | 0.9 | L/ha | AB | 0 | 0 | 0 | 0 | 0 | 0 |
| PA 975 g/ha | 1.5 | L/ha | AB | 0 | 0 | 0 | 2.25 | 0.25 | 0 |
| PA 1300 g/ha | 2.0 | L/ha | AB | 12.5 | 13.75 | 2.75 | 10.5 | 4.25 | 4 |
| PA 2600 g/ha | 4.0 | L/ha | AB | 31.25 | 27.5 | 12.5 | 70 | 60 | 57.5 |
| Decis Mega 50 EW | 0.15 | L/ha | AB | 0 | 0 | 0 | 0 | 0 | 0 |

| Crop | | | | Pea | Pea | Pea | Pea | Pea |
|---|---|---|---|---|---|---|---|---|
| Description | | | | PHYNEC | PHYNEC | PHYNEC | PHYNEC | PHYNEC |
| Trt-Eval interval | | | | 3 DAA | 7 DAA | 13 DAA | 4 DAB | 8 DAB |
| Treatment | Rate | Rate | Application | | | | | |
| name | | unit | code | | | | | |
| UTC | | | | | | | | |
| PA 585 g/ha | 0.9 | L/ha | AB | 0 | 0 | 0 | 0 | 0 |
| PA 975 g/ha | 1.5 | L/ha | AB | 0 | 0 | 0 | 0 | 0 |
| PA 1300 g/ha | 2.0 | L/ha | AB | 6.8 | 4.5 | 1.3 | 0 | 0 |
| PA 2600 g/ha | 4.0 | L/ha | AB | 16.5 | 12 | 4.5 | 2.8 | 2 |
| Scatto | 0.25 | L/ha | AB | 0 | 0 | 0 | 0 | 0 |

Scatto = deltamethrin 25 g/L

### Example 8

Potatoes—Leptinotarsa decemlineata (Colorado Potato Beetle)—LEPTNDE

Trial 1: Potatoes, variety Lady Amarilla, 4 replicates per plot, each plot at least 25 m². A water volume of 200 L water/ha was used for each application. Two applications were made at a 14d interval.

Application made at the occurrence of the insects. Application A was made at Stage BBCH 36, application B was made 14 days later at Stage BBCH 51.

Insects present at the time of application: at App A 39/10 plants at App B in untreated: 35/10 plants.

| Pest | | | | Leptinotarsa | Leptinotarsa |
|---|---|---|---|---|---|
| | | | | decemlineata | decemlineata |
| Crop | | | | Potato | Potato |
| Description | | | | COUINS | COUINS |
| Part rated | | | | # L1-L3/10 plants | # L4/10 plants |
| Rating unit | | | | % UNCK | % UNCK |
| Sample size | | | | 10 plants | 10 plants |
| Trt-Eval interval | | | | 8 DAB | 8 DAB |
| | | | Application | | |
| Treatment Name | Rate | Rate unit | code | | |
| UTC (#i) | | | | 4.3 | 4.8 |
| PA 585 g/ha | 0.9 | L/ha | AB | 88.2 | 57.9 |
| PA 975 g/ha | 1.5 | L/ha | AB | 17.6 | 57.9 |
| PA 1300 g/ha | 2.0 | L/ha | AB | 82.4 | 57.9 |
| PA 2600 g/ha | 4.0 | L/ha | AB | 76.5 | 68.4 |
| Spintor 48 SC | 0.05 | L/ha | AB | 94.1 | 89.5 |

Spintor 48 SC = Spinosad 480 g/L SC

Phytotoxicity - General Injury (PHYGEN)

| Crop | | | | Potato | Potato | Potato | Potato |
|---|---|---|---|---|---|---|---|
| Description | | | | PHYGEN | PHYGEN | PHYGEN | PHYGEN |
| Trt-Eval interval | | | | 7 DAA | 15 DAA | 3 DAB | 8 DAB |
| Treatment | | Rate | Application | | | | |
| name | Rate | unit | code | | | | |
| UTC (#i) | | | | 0 | 0 | 0 | 0 |
| PA 585 g/ha | 0.9 | L/ha | AB | 0 | 0 | 0 | 0 |
| PA 975 g/ha | 1.5 | L/ha | AB | 1.3 | 0 | 0 | 0 |
| PA 1300 g/ha | 2.0 | L/ha | AB | 1 | 0 | 1 | 1 |
| PA 2600 g/ha | 4.0 | L/ha | AB | 6 | 4 | 4.5 | 5 |
| Spintor 48 | 0.05 | L/ha | AB | 0 | 0 | 0 | 0 |
| SC | | | | | | | |

Trial 2: Potatoes, 4 replicates per plot, each plot at least 25 m². A water volume of 200 L water/ha was used for each application. Two applications were made at a 14d interval.

Application made at the occurrence of the insects. Application A was made at Stage BBCH 39-41, application B was made 14 days later at Stage BBCH 41-44.

Insects present at the time of application: at App A: 9/10 plants at App B in untreated: 44/10 plants

| Pest | | | | LEPTNDE | LEPTNDE | LEPTNDE | LEPTNDE | LEPTNDE |
|---|---|---|---|---|---|---|---|---|
| Crop | | | | Potato | Potato | Potato | Potato | Potato |
| Description | | | | COUINS | COUINS | COUINS | COUINS | COUINS |
| Part rated | | | | # L1- | # L4/10 | # L1- | # L4/10 | Adults/10 |
| | | | | L3/10 | plants | L3/10 | plants | plants |
| | | | | plants | | plants | | |
| Rating unit | | | | % UNCK | % UNCK | % UNCK | % UNCK | % UNCK |
| Sample size | | | | 10 plants | 10 plants | 10 plants | 10 plants | 10 plants |
| Trt-Eval interval | | | | 7 DAA | 7 DAA | 10 DAB | 10 DAB | 10 DAB |
| Treatment | Rate | Rate | Application | | | | | |
| name | | unit | code | | | | | |
| UTC (#) | | | | 18.8 | 20.3 | 29.5 | 37.5 | 41.5 |
| PA 585 g/ha | 0.9 | L/ha | AB | 51.7 | 45 | 68.6 | 64.2 | 48 |
| PA 975 g/ha | 1.5 | L/ha | AB | 48.5 | 35 | 76 | 77 | 55 |
| PA 1300 g/ha | 2.0 | L/ha | AB | 70.9 | 59.9 | 89.8 | 86.2 | 69 |
| PA 2600 g/ha | 4.0 | L/ha | AB | 73.4 | 80.9 | 93.4 | 92.8 | 78.9 |
| Decis | 0.5 | L/ha | AB | 36.9 | 51.8 | 80.9 | 87.9 | 76.9 |

Decis = deltamethrin

A total of 3 trials with treatment list as above were assessed for phytotoxicity. Each trial had 0% phyto (PHYGEN) at each assessment timing for each treatment.

### Example 9

Comparison of the levels of phytotoxicity of pelargonic acid to a commercially important insecticide (Deltamethrin) for potato.

Application made at the occurrence of the insects. Stage of the crop at application A: BBCH 37-38; application B was made 14 days later Stage BBCH 55-59.

| Crop | | | | Potato | Potato | Potato |
|---|---|---|---|---|---|---|
| Description | | | | PHYGEN | PHYGEN | PHYGEN |
| Trt-Eval interval | | | | 7 DAA | 7 DAA | 9 DAB |
| Treatment | Rate | Rate | Application | | | |
| name | | unit | code | | | |
| UTC (#i) | | | | 0 | 0 | 0 |
| PA 585 g/ha | 0.9 | L/ha | AB | 0 | 0 | 0 |
| PA 975 g/ha | 1.5 | L/ha | AB | 0 | 0 | 0 |
| PA 1300 g/ha | 2.0 | L/ha | AB | 0.5 | 0.3 | 0.5 |
| PA 2600 g/ha | 4.0 | L/ha | AB | 8.8 | 8.8 | 10 |
| Scatto | 0.3 | L/ha | AB | 0 | 0 | 0 |

### Example 10

Potatoes—Myzus persicae (Green Aphids)—MYZUPE

Potatoes, variety Agata, 4 replicates per plot. A water volume of 200 L water/ha was used for each application. Two applications were made at a 14d interval.

Application made at the occurrence of the insects. Application A was made at Stage BBCH 38-41, application B was made 14 days later at Stage BBCH 41-43.

Insects present at the time of application: at App A 93 aphids per 25 leaves at App B in untreated: 160 aphids per 25 leaves

| Pest | | | | MYZUPE | MYZUPE | MYZUPE | MYZUPE | MYZUPE | MYZUPE |
|---|---|---|---|---|---|---|---|---|---|
| Crop | | | | Potato | Potato | Potato | Potato | Potato | Potato |
| Description | | | | COUINS | COUINS | COUINS | COUINS | COUINS | COUINS |
| Part rated | | | | leaves | leaves | leaves | leaves | leaves | leaves |
| Rating unit | | | | % UNCK | % UNCK | % UNCK | % UNCK | % UNCK | % UNCK |
| Sample size | | | | #/25 | #/25 | #/25 | #/25 | #/25 | #/25 |
| | | | | leaves | leaves | leaves | leaves | leaves | leaves |
| Trt-Eval interval | | | | 3 DAA | 7 DAA | 14 DAA | 3 DAB | 7 DAB | 14 DAB |
| Treatment | Rate | Rate | Application | | | | | | |
| name | | unit | code | | | | | | |
| UTC (# | | | | 118 | 141 | 159.5 | 170 | 178 | 191 |
| Insects) | | | | | | | | | |
| PA 585 g/ha | 0.9 | L/ha | AB | 38.8 | 48.7 | 52.3 | 68.8 | 68.4 | 73.4 |
| PA 975 g/ha | 1.5 | L/ha | AB | 42.9 | 51.2 | 54.9 | 72.6 | 72.4 | 73.2 |
| PA 1300 g/ha | 2.0 | L/ha | AB | 61.9 | 63.9 | 67.3 | 86.1 | 86.1 | 86.5 |
| PA 2600 g/ha | 4.0 | L/ha | AB | 68.4 | 70.8 | 74.2 | 92.6 | 92.5 | 92.4 |
| Decis | 0.5 | L/ha | AB | 94.1 | 94.2 | 93.7 | 98 | 97.6 | 97.5 |

Phytotoxicity: PHYGEN: 0% for each treatment at each assessment timing

### Example 11

Potatoes—Diabrotica speciosa (Cucurbit Beetle)—DIABSC

### Trial 1

A water volume of 400 L water/ha was used for each application. Application A made at the occurrence of the insects; application B was made 7 days later.

| Pest | | | | DIABSC | DIABSC | DIABSC | DIABSC |
|---|---|---|---|---|---|---|---|
| Crop | | | | Potato | Potato | Potato | Potato |
| Description | | | | # Insects | # Insects | # Insects | # Insects |
| Part rated | | | | 20 plants | 20 plants | 20 plants | 20 plants |
| Rating unit | | | | % UNCK | % UNCK | % UNCK | % UNCK |
| Sample size | | | | 20 leaves | 20 leaves | 20 leaves | 20 leaves |
| Trt-Eval interval | | | | 3 DAA | 7 DAA | 3 DAB | 7 DAB |
| Treatment | Rate | Rate | Application | | | | |
| name | | unit | code | | | | |
| UTC (# | | | | 7.75a | 8.5a | 9.5a | 9.25a |
| Insects) | | | | | | | |
| PA 487.5 g/ha | 0.75 | L/ha | AB | 48.39ab | 29.4ab | 34.2b1 | 54.05b |
| PA 650 g/ha | 1 | L/ha | AB | 67.74b | 55.88abc | 84.21c | 81.08b |
| PA 812.5 g/ha | 1.25 | L/ha | AB | 64.52b | 61.76bc | 86.84c | 83.78b |
| PA 975 g/ha | 1.5 | L/ha | AB | 74.19b | 64.71bc | 84.21c | 83.78b |
| Actara | 0.05 | kg/ha | AB | 80.65b | 76.47c | 86.84c | 81.08b |

Actara = thiamethoxam 25% WG
Phytotoxicity: PHYGEN: 0% for each treatment at each assessment timing (7 days after each treatment)

### Trial 2

A water volume of 400 L water/ha was used for each application. Application A made at the occurrence of the insects; application B was made 7 days later.

Each plot was 15 m².

5.15 insects per 20 plants were present at the time of application.

| Pest | | | | DIABSC | DIABSC | DIABSC | DIABSC | DIABSC |
|---|---|---|---|---|---|---|---|---|
| Crop | | | | Potato | Potato | Potato | Potato | Potato |
| Description | | | | # Insects | # Insects | # Insects | # Insects | # Insects |
| Part rated | | | | 20 plants | 20 plants | 20 plants | 20 plants | 20 plants |
| Rating unit | | | | % UNCK | % UNCK | % UNCK | % UNCK | % UNCK |
| Sample size | | | | 20 leaves | 20 leaves | 20 leaves | 20 leaves | 20 leaves |
| Trt-Eval interval | | | | 3 DAA | 7 DAA | 3 DAB | 7 DAB | 10 DAB |
| Treatment | Rate | Rate | Application | | | | | |
| name | | unit | code | | | | | |
| UTC (# | | | | 5.25a | 5.25a | 7.00a | 6.00a | 5.75a |
| Insects) | | | | | | | | |
| PA 487.5 g/ha | 0.75 | L/ha | AB | 38.10b | 23.81ab | 25.00ab | 70.83b | 68.57b |
| PA 650 g/ha | 1 | L/ha | AB | 61.90bc | 38.10b | 25.00ab | 87.50bc | 86.96bc |
| PA 812.5 g/ha | 1.25 | L/ha | AB | 80.95cd | 85.71c | 28.57b | 91.67c | 91.30c |
| PA 975 g/ha | 1.5 | L/ha | AB | 95.24de | 100.00d | 53.57c | 100.00c | 100.00c |
| Actara | 0.05 | kg/ha | AB | 100e | 100.00d | 60.71c | 100.00c | 100.00c |

Actara = thiamethoxam 25% WG
Phytotoxicity: PHYGEN: 0% for each treatment at each assessment timing (7 days after each treatment)

### Example 12

Dry Beans—Diabrotica speciosa

Trial 1: A water volume of 150 L water/ha was used for each application. Two applications were made at a 7d interval. Application A was made at first infestation.

Each plot was 15 m².

| Pest | | | | DIABSC | DIABSC |
|---|---|---|---|---|---|
| Crop | | | | Dry bean | Dry bean |
| Description | | | | % | Yield |
| | | | | Damage | |
| Part rated | | | | 20 | / |
| | | | | trifoliata | |
| Rating unit | | | | % UNCK | Ton/ha |
| Sample size | | | | %/20 | Plot |
| | | | | leaves | |
| Trt-Eval interval | | | | 28 DAB | / |
| Treatment | | Rate | Application | | |
| name | Rate | unit | code | | |
| UTC | | | | 14.14a | 2.08b |
| (#insects) | | | | | |
| PA 650 | 1 | L/ha | AB | 27.81a | 2.09b |
| g/ha | | | | | |
| PA 812.5 | 1.25 | L/ha | AB | 82.01b | 2.28ab |
| g/ha | | | | | |
| PA 975/ha | 1.5 | L/ha | AB | 86.96b | 2.37ab |
| PA 1137.5 | 1.75 | L/ha | AB | 88.90b | 2.34ab |
| g/ha | | | | | |
| Lambda- | 0.15 | L/ha | AB | 80.55b | 2.55a |
| cyhalothrin | | | | | |
| 100 | | | | | |

Phytotoxicity: PHYGEN: 0% for each treatment at each assessment timing (7 days after each treatment)

Trial 2: A water volume of 150 L water/ha was used for each application. Two applications were made at a 7d interval. Application A was made at first infestation.

Each plot was 15 m².

| Pest | | | | DIABSC | DIABSC |
|---|---|---|---|---|---|
| Crop | | | | Dry bean | Dry bean |
| Description | | | | % | Yield |
| | | | | Damage | |
| Part rated | | | | 20 | / |
| | | | | trifoliata | |
| Rating unit | | | | % UNCK | Ton/ha |
| Sample size | | | | %/20 | Plot |
| | | | | leaves | |
| Trt-Eval interval | | | | 28 DAB | / |
| Treatment | | Rate | Application | | |
| name | Rate | unit | code | | |
| UTC | | | | 16.24a | 2.09d |
| (#insects) | | | | | |
| PA 650 | 1 | L/ha | AB | 39.58b | 2.11cd |
| g/ha | | | | | |
| PA 812.5 | 1.25 | L/ha | AB | 81.64c | 2.15cd |
| g/ha | | | | | |
| PA 975 | 1.5 | L/ha | AB | 87.8c | 2.19bc |
| g/ha | | | | | |
| PA 1137.5 | 1.75 | L/ha | AB | 88.11c | 2.29a |
| g/ha | | | | | |
| Lambda- | 0.15 | L/ha | AB | 81.41c | 2.29ab |
| cyhalothrin | | | | | |
| 100 | | | | | |

Phytotoxicity: PHYGEN: 0% for each treatment at each assessment timing (7 days after each treatment)

### Example 13

### Egg Trial

Halyomorpha halys were obtained from a lab strain that was mass reared for several generations from a field strain. Egg masses were provided at the same stage (2-3 days before hatching) in order to test same egg masses conditions.

Bioassay, consisting in egg masses immersion, was carried out dipping the egg masses by means of lab forceps for two second inside three different PA product concentrations (100 ppm, 50 ppm and 33 ppm), one treatment with a commercial standard (Trebon up, a.i., Etofenprox) and a treatment with only water (untreated Check) were performed. 4 replicates were performed (1 egg mass is considered 1 replicate).

Assessments were conducted at 1, 2, 4 days after application, egg mortality and larvae hatching from eggs were recorded, raw data were processed with ARM software. All the statistical procedures [Student-Newman-Keuls (SNK)], Anova and other calculation analysis were performed using the ARM 2020.0 software.

### Results

| | | | | | | | | % Live | |
|---|---|---|---|---|---|---|---|---|---|
| | | Rate | | Rate | Appl. | % Egg | | instars | |
| Treatment | rate | unit | Rate | Unit | code | mortality | | emerged | |
| pelargonic | 100 | ppm ai | 10 | ml/l | A | 65 | a | 5 | b |
| acid 650 g/l | | | | | | | | | |
| pelargonic | 50 | ppm ai | 5 | ml/l | A | 46 | ab | 18 | b |
| acid 650 g/l | | | | | | | | | |
| pelargonic | 33 | ppm ai | 3.3 | ml/l | A | 17 | bc | 47 | ab |
| acid 650 g/l | | | | | | | | | |
| Trebon Up | 144 | ppm ai | 0.5 | ml/l | A | 6 | c | 54 | ab |

| | | | | | |
|---|---|---|---|---|---|
| Untreated check | Distilled water | 0 | c | 100 | a |

### Example 14

Spodoptera exigua were obtained from a lab strain that was mass reared for several generations. Eggs were collected at the same stage in order to test same egg conditions. 50 eggs were treated per condition. Eggs were treated with the product using a forceps and paper wick. Larval emergence and survival were observed under the microscope until day 3 after treatment.

| | | | | # Emerged | % Emerged |
|---|---|---|---|---|---|
| | | Rate | treated | larvae | larvae |
| | Rate | unit | eggs | (3 DAT) | (3 DAT) |
| pelargonic acid | 5 | ml/l | 50 | 0 | 0 |
| 650 g/l | | | | | |
| pelargonic acid | 3 | ml/l | 50 | 22 | 44 |
| 650 g/l | | | | | |
| Untreated | / | | 50 | 48 | 96 |
| check | | | | | |

1. A method of controlling arthropod pests, preferably insect and/or acari pests, on vegetable plants, which comprises applying a pesticidally effective amount of pelargonic acid to a pest, to a locus of a pest, or to a plant susceptible to attack by a pest.

2. A method for controlling and/or preventing damage by infestation of arthropod pests, preferably insect and/or acari pests, on vegetable plants, which comprises applying a pesticidally effective amount of pelargonic acid to a plant.

3. A process of using of pelargonic acid on vegetable plants for controlling and/or or preventing damage by infestation of arthropod pests.

4. The method according to claim 1, wherein the pests comprise at least one member selected from the group consisting of Tetranychus urticae, Acalymma vittatum, Cerotoma trifurcata, Crioceris asparagi, Crioceris duodecimpunctata, Diabrotica spp., for example, Diabrotica speciosa, Diabrotica undecimpunctata howardi, Disonycha xanthomelas, family Elateridae, Epicauta spp., Epilachna varivestis, Epitrix spp., for example Epitrix cucumeris, Epitrix fuscula, Leptinotarsa decemlineata, Listronotus oregonensis, Metriona bicolor, Phyllotreta cruciferae, Phyllotreta striolata, family Scarabaeidae, Systena spp., Systena blanda, Delia antiqua, Delia platura, Delia radicum, Liriomyza sativae, Ophiomyia simplex, Pegomya hyoscyami, Phytomyza gymnostoma, Tritoxa flexa, Acyrthosiphon pisum, Aphis spp., for example, Aphis fabae, Aphis gossypii, Brevicoryne brassicae, Empoasca fabae, Erthesina fullo, Lipaphis erysimi, Macrosiphum euphorbiae, Myzus persicae, Anasa tristis, Halyomorpha halys, Lygus lineolaris, family Pentomidae, family Aleyrodidae, Brachycorynella asparagi, Macrosteles quadrilineatus, Agrotis ipsilon, Colias eurytheme, Evergestos rimosalis, Helicoverpa zea, Manduca spp., for example, Manduca sexta, Manduca quinquemaculata, Melittia cucurbitae, family Noctuidae, Ostrinia nubilalis, Peridroma saucia, Pieris rapae, Plathypena scabra, Plutella xylostella (=Plutella maculipennis), Ptorimaea operculella, Spodoptera spp., for example, Spodoptera exigua, Spodoptera frugiperda, Trichoplusia ni, Tuta absoluta, Frankliniella tritici and Thrips tabaci.

5. The methods according to claim 1, wherein the vegetable plant is selected from Solanum lycopersicum, preferably tomato, Capsicum annuum, preferably pepper, bell pepper and sweet pepper or Solanum melongena, preferably, eggplant, and the plant pest comprises at least one member selected from the group consisting of Tetranychus urticae, Diabrotica speciosa, Epitrix cucumeris, Epitrixfuscula, Leptinotarsa decemlineata, Systena blanda, Erthesina fullo, Macrosiphum euphorbiae, Myzus persicae, Halyomorpha halys, Lygus lineolaris, family Pentomidae, family Aleyrodidae, Helicoverpa zea, Manduca sexta, Manduca quinquemaculata, Ostrinia nubilalis, Peridroma saucia, Spodoptera exigua, Spodoptera frugiperda and Tuta absoluta; most preferably, the vegetable plant is tomato and the pest is selected from Leptinotarsa decemlineata, Halyomorpha halys, Spodoptera exigua, and Tuta absoluta.

6. The methods according to claim 1, wherein the vegetable plant is selected from Phaseolus spp., Viciafaba or Pisum sativum and the plant pest comprises at least one member selected from the group consisting of Tetranychus urticae, Cerotoma trifurcata, Diabrotica speciosa, Epilachna varivestis, Delia platura, Acyrthosiphon pisum, Aphis fabae, Empoasca fabae, Erthesina fullo, Halyomorpha halys, Colias eurytheme, Helicoverpa zea, Ostrinia nubilalis and Plathypena scabra; most preferably, the pest is selected from Diabrotica speciosa, Acyrthosiphon pisum, Aphis fabae and Halyomorpha halys.

7. The methods according to claim 1, wherein the vegetable plant is Brassica oleracea and the plant pest comprises at least one member selected from the group consisting of Diabrotica speciosa, Phyllotreta cruciferae, Phyllotreta striolata, Delia radicum, Brevicoryne brassicae, Erthesina fullo, Lipaphis erysimi, Myzus persicae, Halyomorpha halys, Evergestos rimosalis, Pieris rapae, Plutella xylostella (=Plutella maculipennis), Spodoptera frugiperda, Trichoplusia ni, Frankliniella tritici and Thrips tabaci.

8. The methods according to claim 1, wherein the vegetable plant is Cucurbita spp. and the plant pest comprises at least one member selected from the group consisting of Tetranychus urticae, Acalymma vittatum, Diabrotica speciosa, Diabrotica undecimpunctata howardi, Aphis gossypii, Erthesina fullo, Anasa tristis, Melittia cucurbitae and Trichoplusia ni.

9. The methods according to claim 1, wherein the vegetable plant is selected from Ipomoea batatas, preferably sweet potato, Asparagus officinalis, preferably asparagus, and Allium cepa, preferably, onion, and the plant pest comprises at least one member selected from the group consisting of Crioceris Crioceris asparagi, Crioceris duodecimpunctata, Diabrotica speciosa, Diabrotica undecimpunctata howardi, family Elateridae, Metriona bicolor, family Scarabaeidae, Systena spp., Systena blanda, Delia antiqua, Erthesina fullo, Ophiomyia simplex, Phytomyza gymnostoma, Tritoxa flexa, Brachycorynella asparagi, Agrotis ipsilon, family Noctuidae and Thrips tabaci.

10. The methods according to claim 1, wherein the vegetable plant is selected from Spinacia oleracea, preferably spinach, Lactuca sativa, preferably lettuce, and Daucus carota, preferably carrots, and the plant pest comprises at least one member selected from the group consisting of Diabrotica speciosa, Diabrotica undecimpunctata howardi, Disonycha xanthomelas, Listronotus oregonensis, Systena blanda, Liriomyza sativae, Pegomya hyoscyami, Erthesina fullo, Myzus persicae, Lygus lineolaris, Macrosteles quadrilineatus, Helicoverpa zea, family Noctuidae, Spodoptera exigua, and Trichoplusia ni.

11. The methods according to claim 1, wherein the vegetable plant is Solanum tuberosum, preferably potato, and the plant pest comprises at least one member selected from the group consisting of Tetranychus urticae, Diabrotica speciosa, family Elateridae, Epicauta spp., Epitrix spp., Leptinotarsa decemlineata, Delia platura, Empoasca fabae, Erthesina fullo, Macrosiphum euphorbiae, Myzus persicae, Agrotis ipsilon, Manduca spp. and Ptorimaea operculella; preferably, the pest is selected from Diabrotica speciosa, Leptinotarsa decemlineata and Myzus persicae.

12. The methods according to claim 1, wherein the pest is Aphis spp., preferably Aphis fabae or Aphis gossypii and the plant is selected from Cucurbita spp., Phaseolus spp., Vicia faba and Pisum sativum.

13. The methods according to claim 1, wherein the pest is Diabrotica spp., preferably Diabrotica speciosa and Diabrotica undecimpunctata howardi and the plant is selected from Solanum lycopersicum, preferably tomato, Capsicum annuum, preferably pepper, bell pepper and sweet pepper or Solanum melongena, preferably, eggplant, Phaseolus spp., Vicia faba or Pisum sativum, Brassica oleracea, Cucurbita spp., Ipomoea batatas, preferably sweet potato, Asparagus officinalis, preferably asparagus, and Allium cepa, preferably, onion, Spinacia oleracea, preferably spinach, Lactuca sativa, preferably lettuce, and Daucus carota, preferably carrots, Solanum tuberosum, preferably potato.

14. The methods according to claim 1, wherein the pest is Spodoptera spp., preferably, Spodoptera exigua or Spodoptera frugiperda and the plant is selected from Solanum lycopersicum, preferably tomato, Capsicum annuum, preferably pepper, bell pepper and sweet pepper, Solanum melongena, preferably, eggplant, Brassica oleracea, Spinacia oleracea, Lactuca sativa and Daucus carota.

15. The methods according to claim 1, wherein the pest is Tetranychus urticae, and the plant is selected from Solanum lycopersicum, preferably tomato, Capsicum annuum, preferably pepper, bell pepper and sweet pepper or Solanum melongena, preferably, eggplant, Phaseolus spp., Vicia faba or Pisum sativum, Cucurbita spp., and Solanum tuberosum, preferably potato.

16. The methods according to claim 1, wherein the pest is Leptinotarsa decemlineata and the plant is selected from Solanum lycopersicum, preferably tomato, Capsicum annuum, preferably pepper, bell pepper and sweet pepper, Solanum melongena, preferably, eggplant, and Solanum tuberosum, preferably potato.

17. The methods according to claim 1, wherein the pest is Myzus persicae and the plant is selected from Solanum lycopersicum, preferably tomato, Capsicum annuum, preferably pepper, bell pepper and sweet pepper or Solanum melongena, preferably, eggplant, Brassica oleracea, Spinacia oleracea, preferably spinach, Lactuca sativa, preferably lettuce, Daucus carota, preferably carrots, and Solanum tuberosum, preferably potato.

18. The methods according to claim 1, wherein the pelargonic acid is applied as a composition together with a suitable carrier.

19. The methods according to claim 1, wherein the pelargonic acid is applied as a foliar spray.

20. The methods according to claim 1, wherein the plant exhibits low phytotoxicity following application of the pelargonic acid.

21. The methods according to claim 1, wherein the pelargonic acid is applied at a rate sufficient to deliver pelargonic acid to the vegetable plants in an amount of from 300 to 6,500 g/ha, preferably from 450 to 4,500 g/ha.

22. The methods according to claim 1, further comprising applying (B) at least one additional pesticidally active agent.

23. The methods according to claim 22, wherein the at least one additional pesticidally active agent (B) comprises at least one member selected from the group consisting of abamectin, acephate, acetamiprid, acrinathrin, afidopyropen, aldicarb, amitraz, azocyclotin, bifenazate, bifenthrin, broflanilide, buprofezin, cadusafos, carbaryl, carbofuran, carbosulfan, chlorantraniliprole, chlorfenapyr, chlorpyrifos, chlorpyrifos-methyl, clofentezine, clothianidin, cyantraniliprole, cyfluthrin, beta-cyfluthrin, lambda-cyhalothrin, cyhexatin, cypermethrin, alpha-cypermethrin, cyromazine, deltamethrin, dicofol, diflubenzuron, dimethoate, dimpropyridaz, disulfoton, emamectin benzoate, esfenvalerate, ethiprole, ethoprophos, etofenprox, etoxazole, fenamiphos, fenazaquin, fenbutatin oxide, fenitrothion, fenoxycarb, fenpropathrin, fenpyroximate, fenvalerate, fipronil, flonicamid, fluazaindolizine, flubendiamide, flufenoxuron, tau-fluvalinate, fosthiazate, hexythiazox, imidacloprid, indoxacarb, lufenuron, malathion, metaflumizone, metam, methamidophos, methiocarb, methoxyfenozide, novaluron, oxamyl, parathion-methyl, permethrin, phorate, pirimicarb, profenofos, propargite, pymetrozine, pyridaben, spinetoram, spinosad, spirodiclofen, spiromesifen, spiropidion, spirotetramat, sulfoxaflor, tebufenozide, tebufenpyrad, tefluthrin, terbufos, tetraniliprole, thiacloprid, thiamethoxam, tioxazafen and biological control agents.

24. The method of claim 23, wherein the biological control agent comprises at least one member selected from the group consisting of Bacillus thuringiensis; Chromobacterium subtsugae, Bacillus popilliae; Beauveria bassiana; Lecanicillium muscarium; Metarhizium anisopliae; Isaria fumosorosea; Lagenidium giganteum; Nosema locustae; Helicoverpa zea single nucleopolyhedrovirus; Lymantria dispar (gypsy moth) multiple nucleopolyhedrovirus; Spodoptera frugiperda (fall armyworm) multiple nucleopolyhedrovirus; Adoxophyes orana (summer fruit tortrix) granulovirus; Cydia pomonella (codling moth) granulovirus; Helicoverpa armigera (cotton bollworm) granulovirus; Plodia interpunctella granulovirus; Spodoptera exigua (beet armyworm) nucleopolyhedrovirus; Zucchini yellow mosaic virus; Bacillus firmus; Pasteuria nishizawae; Pasteuria usgae; Purpureocillium lilacinum and Myrothecium verrucaria.

25. The method according to claim 22, comprising the step of simultaneously or sequentially applying (A) pelargonic acid and (B) at least one pesticidally active agent to a plant.

26. The method of claim 25, wherein the pelargonic acid and the pesticidally active agent are applied simultaneously.

27. The method of claim 25, wherein the pelargonic acid and the pesticidally active agent are applied sequentially.
